(19) United States
(12) Patent Application Publication
(10) Pub. No.: US 2025/0139508 A1
(43) Pub. Date: May 1, 2025

(54) INFORMATION PROCESSING METHOD, INFORMATION PROCESSING APPARATUS, AND NON-TRANSITORY COMPUTER-READABLE STORAGE MEDIUM

(71) Applicant: Actapio, Inc., East Wenatchee, WA (US)

(72) Inventor: Shinichiro OKAMOTO, Wenatchee, WA (US)

(21) Appl. No.: 18/586,944

(22) Filed: Feb. 26, 2024

Related U.S. Application Data
(60) Provisional application No. 63/593,902, filed on Oct. 27, 2023.

(51) Int. Cl. G06N 20/00

(52) U.S. Cl. CPC G06N 20/00

(57) ABSTRACT

An information processing method includes: obtaining the learning data which is to be used in the learning of a base model that treats texts as the input; and performing a multistage learning operation with the use of the learning data, and generating the base model.

### TECHNICAL FIELD

The present invention relates to an information processing method, an information processing apparatus, and a non-transitory computer-readable storage medium having stored therein an information processing program.

### BACKGROUND ART

In recent years, a technology has been proposed in which a model is generated by learning the features of the learning data in regard to various types of models, such as a language model. A model such as a language model that is learnt in the manner mentioned above is used in a variety of inference operations such as various predictions and classifications.
[Patent Literature 1] Japanese Patent Application Laid-open No. 2023-072863

### DISCLOSURE OF INVENTION

### Problem to be Solved by the Invention

In the technology mentioned above, there is room for improvement as far as the generation of a model is concerned. For example, in the example explained above, a model can be generated that treats, as the input, sentences including industry-specific expressions and that enables accurate interpretation of those expressions. However, there is room for improvement as far as the learning of a model is concerned, and there is a demand for enabling generation of a model in a more flexible manner. For example, regarding a base model that can be used as part of a model having various applications or regarding a fine-tuned model that is fine-tuned to be applicable to a predetermined task, there is room for improvement as far as the learning of such models is concerned. For that reason, for example, there is a demand for enabling generation of the base model in an appropriate manner.

### Means for Solving Problem

An information processing method according to the present application is an information processing method executed by a computer, the information processing method comprising: obtaining learning data which is to be used in learning of a base model that treats a text as input; and performing a multistage learning operation using the learning data, and generating the base model.

### Effect of the Invention

According to an aspect of the embodiment, it becomes possible to generate the base model in an appropriate manner.

### BRIEF DESCRIPTION OF DRAWINGS

FIG. 1 is a diagram illustrating an example of an information processing system according to an embodiment.

FIG. 2 is a diagram for explaining an exemplary flow of model generation performed using an information processing apparatus according to the embodiment.

FIG. 3 is a diagram illustrating an exemplary configuration of the information processing apparatus according to the embodiment.

FIG. 4 is a diagram illustrating an example of the information registered in a learning data database according to the embodiment.

FIG. 5 is a flowchart for explaining an exemplary flow of information processing performed according to the embodiment.

FIG. 6 is a flowchart for explaining an exemplary flow of information processing performed according to the embodiment.

FIG. 7 is a diagram illustrating an exemplary structure of a model according to the embodiment.

FIG. 8 is a diagram illustrating an example of the specification of the input to a model according to the embodiment.

FIG. 9 is a diagram illustrating an example of the specification of the input to a model according to the embodiment.

FIG. 10 is a diagram illustrating an example of the types of the input according to the embodiment.

FIG. 11 is a diagram illustrating an example of the input given to a model according to the embodiment.

FIG. 12 is a diagram illustrating another exemplary structure of a model according to the embodiment.

FIG. 13 is a diagram illustrating an example of the input given to a model according to the embodiment.

FIG. 14 is a diagram illustrating an exemplary experimental result.

FIG. 15 is a diagram illustrating an exemplary experimental result.

FIG. 16 is a diagram illustrating an exemplary experimental result.

FIG. 17 is a diagram illustrating an exemplary experimental result.

FIG. 18 is a diagram illustrating an exemplary experimental result.

FIG. 19 is a diagram for explaining an example of a generation operation for generating a model according to the embodiment.

FIG. 20 is a diagram for explaining an example of a generation operation for generating a model according to the embodiment.

FIG. 21 is a diagram for explaining an example of a generation operation for generating a model according to the embodiment.

FIG. 22 is a diagram illustrating an exemplary experimental result.

FIG. 23 is a diagram illustrating an exemplary experimental result.

FIG. 24 is a diagram illustrating an exemplary experimental result.

FIG. 25 is a diagram illustrating an exemplary experimental result.

FIG. 26 is a diagram illustrating an exemplary hardware configuration.

### BEST MODE(S) OF CARRYING OUT THE INVENTION

An illustrative embodiment (hereinafter, called an “embodiment) of an information processing method, an information apparatus, and a non-transitory computer-readable storage medium having stored therein an information processing program according to the application concerned is described below in detail with reference to the accompanying drawings. However, the information processing method, the information apparatus, and the information processing program according to the application concerned is not limited by the embodiment described below. Moreover, embodiments can be appropriately combined without causing any contraction in the operation details. In embodiments, the same constituent elements are referred to by the same reference numerals, and their explanation is not given again.

### Embodiment

In the embodiment described below, firstly the explanation is given about the premise such as the system configuration, and that is followed by the explanation about the operations related to the generation of a model that treats a text as the input. Thus, in the present embodiment, before explaining about the generation of a model and demonstrating the experimental results, firstly the explanation is given about a configuration of an information processing system 1 configured to generate a model.

### 1. Configuration of Information Processing System

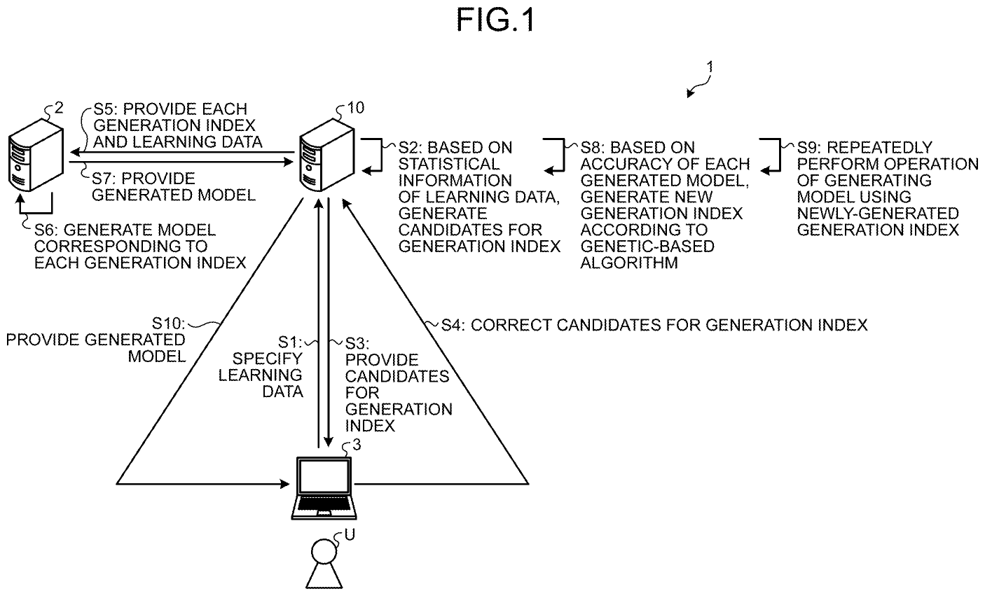

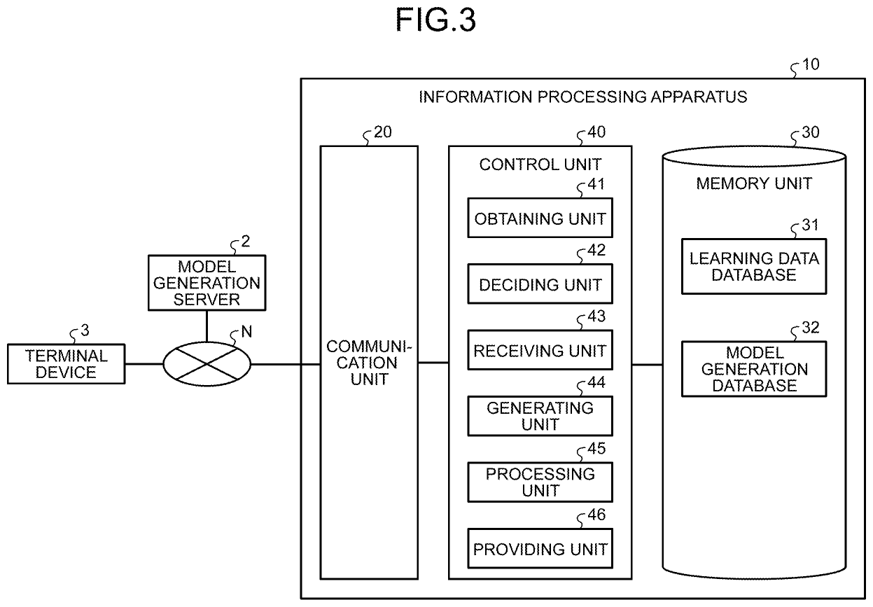

Firstly, explained below with reference to FIG. 1 is a configuration of an information processing apparatus 10 representing an example of the information processing apparatus. FIG. 1 is a diagram illustrating an example of the information processing system according to the embodiment. As illustrated in FIG. 1, the information processing system 1 includes the information processing apparatus 10, a model generation server 2, and a terminal device 3. Herein, the information processing system 1 can include a plurality of model generation servers 2 and a plurality of terminal devices 3. Moreover, the information processing apparatus 10 and the model generation server 2 can be implemented using a single server device or a single cloud system. The information processing apparatus 10, the model generation server 2, and the terminal device 3 are communicably connected to each other in a wired manner or a wireless manner via a network N (for example, see FIG. 3).

The information processing apparatus 10 is an information processing apparatus that performs an index generation operation for generating a generation index representing the index to be used in the generation of a model (that is, representing a recipe of a model); that performs a model generation operation for generating a model according to the generation index; and that provides the generation index and the model. For example, the information processing apparatus 10 is implemented using a server device or a cloud system.

The model generation server 2 is an information processing apparatus that generates a model trained in the features of the learning data, and that is implemented using, for example, a server device or a cloud system. For example, when a configuration file indicating the type and the behavior of the model to be generated and indicating the manner of training regarding the features of the learning data is received as the generation index of the model, the model generation server 2 performs automated generation of the model according to the received configuration file. Meanwhile, the model generation server 2 can implement an arbitrary model learning method to learn about the model. Moreover, for example, the model generation server 2 can be one of various existing services, such as AutoML (Automated Machine Learning).

The terminal device 3 is a terminal device used by a user U and is implemented using, for example, a PC (Personal Computer) or a server device. For example, the terminal device 3 communicates with the information processing apparatus 10 to ensure that the generation index of a model is generated, and obtains the model generated by the model generation server 2 according to the generation index.

### 2. Overview of Operations Performed by the Information Processing Apparatus 10

Firstly, the explanation is given about the overview of the operations performed by the information processing apparatus 10. Firstly, from the terminal device 3, the information processing apparatus 10 receives an indication of the learning data to be used in training a model in the features (Step S1). For example, the information processing apparatus 10 stores a variety of learning data, which is to be used in learning, in a predetermined memory device, and receives an indication of the learning data that is specified by the user U as the learning data. Alternatively, for example, the information processing apparatus 10 can obtain the learning data, which is to be used in learning, from the terminal device 3 or various external servers.

Herein, an arbitrary type of data can be used as the learning data. For example, as the learning data, the information processing apparatus 10 can treat a variety of information related to the users, such as the history of the locations of each user, the history of the web contents browsed by each user, the history of the purchases made by each user, and the history of the search queries entered by each user. Moreover, the information processing apparatus 10 can also treat the demographic attributes and the psychographic attributes of the users as the learning data. Furthermore, the information processing apparatus 10 can treat, as the learning data, metadata such as the types, the details, and the creators of various web contents to be delivered.

In this case, based on the statistical information about the learning data to be used in learning, the information processing apparatus 10 generates candidates for the generation index (Step S2). For example, based on the features of the values included in the learning data, the information processing apparatus 10 generates candidates for the generation index that indicate the suitable learning method. In other words, as the generation index, the information processing apparatus 10 generates a model capable of accurately learning the features of the learning data or generates a learning method for accurately training a model in the features. That is, the information processing apparatus 10 optimizes the learning method. Meanwhile, regarding the correspondence between the selection of the learning data and the details of the generation index that gets generated, the explanation is given later.

Then, the information processing apparatus 10 provides the candidates for the generation index to the terminal device 3 (Step S3). In this case, the user U corrects the candidates for the generation index according to the liking and the empirical rules (Step S4). Subsequently, the information processing apparatus 10 provides the candidates for the generation index and the learning data to the model generation server 2 (Step S5).

The model generation server 2 generates a model corresponding to each generation index (Step S6). For example, the model generation server 2 trains a model, which has a structure indicated by a generation index, in the features of the learning data according to the learning method indicated by the generation index. Then, the model generation server 2 provides the generated model to the information processing apparatus 10 (Step S7).

Herein, it is believed that each model generated by the model generation server 2 has a different accuracy attributed to the difference in the corresponding generation index. In that regard, the information processing apparatus 10 generates a new generation index according to a genetic-based algorithm and based on the accuracy of each model (Step S8) and repeatedly performs the operation of generating a model using the newly-generated generation index (Step S9).

For example, the information processing apparatus 10 divides the learning data into data for evaluation and data for learning, and obtains a plurality of models each of which has been trained in the features of the data for learning and has been generated according to a different generation index. For example, the information processing apparatus 10 generates 10 generation indexes, and generates 10 models using the 10 generation indexes and using the data for learning. In that case, the information processing apparatus 10 measures the accuracy of each of the 10 models using the data for evaluation.

Then, from among the 10 models, the information processing apparatus 10 selects a predetermined number of models (for example, five) in descending order of accuracy. Then, from the generation indexes that were used in generating the selected five models, the information processing apparatus 10 generates new generation indexes. For example, the information processing apparatus 10 treats each generation index as the body of a genetic-based algorithm; and treats the type of the model indicated by each generation index, the structure of the model indicated by each generation index, and various learning methods (i.e., various indexes indicated by each generation index) as the genes of the genetic-based algorithm. Then, the information processing apparatus 10 selects the bodies to be subjected to the crossover of genes and performs the crossover of genes; and generates 10 new-generation generation indexes. Meanwhile, at the time of performing the crossover of genes, the information processing apparatus 10 can also take into account the mutation. Meanwhile, the information processing apparatus 10 can perform two-point crossover, multipoint crossover, uniform crossover, or random selection of target genes for crossover. Moreover, for example, the information processing apparatus 10 can adjust the crossover ratio during crossover in such a way that the genes of the bodies corresponding to the models having high accuracy are carried over more and more into the next-generation bodies.

Moreover, the information processing apparatus 10 uses the next-generation generation indexes and again generates 10 new models. Then, based on the accuracy of those new 10 models, the information processing apparatus 10 generates new generation indexes according to the genetic algorithm mentioned above. As a result of performing such operations in a repeated manner, the information processing apparatus 10 can move closer to having the generation indexes that correspond to the features of the learning data, that is, move closer to having the optimized generation indexes.

Meanwhile, when a predetermined condition is satisfied such as when the generation of new generation indexes is performed for a predetermined number of times or when the maximum value, the average value, or the minimum value of the accuracy of the models exceeds a predetermined threshold value; the information processing apparatus 10 selects the model having the highest accuracy as the model to be provided. Then, the information processing apparatus 10 provides the selected model and the corresponding generation index to the terminal device 3 (Step S10). Due to such operations, when the user merely selects the learning data, the information processing apparatus 10 can generate the generation index of the appropriate model and can send the model corresponding to that generation index.

Meanwhile, in the example explained above, the information processing apparatus 10 implements stepwise optimization of generation indexes using a genetic-based algorithm. However, the embodiment is not limited to that example. As it would become clear in the explanation given later, the accuracy of a model changes not only according to the features of the model itself such as the type and the structure of the model, but also according to the index at the time of generating a model (i.e., at the time of giving training in the features of the learning data), such as what type of learning data is used and what type of model is the learning data input to, and what type of hyperparameters are to be used for the learning of a model.

In that regard, if the generation index estimated to be the most suitable is to be generated according to the learning data, then the information processing apparatus 10 need not perform the optimization using a genetic-based algorithm. For example, the information processing apparatus 10 can present the generation index to the user depending on whether or not the learning data satisfies various conditions generated according to the empirical rules, and can generate a model according to the presented generation index. Moreover, when any correction is received in the presented generation index, the information processing apparatus 10 can generate a model according to the corrected generation index; can present the accuracy of the generated model to the user; and can again receive a correction in the generation index. That is, the information processing apparatus 10 can allow the user U to perform trial and error about the most suitable generation index.

### 3. Regarding Generation of Generation Index

Given below is the explanation of an example about what type of generation index is to be generated for what type of learning data. However, the following explanation is only exemplary and, as long as a generation index is generated according to the features of the learning data, it is possible to implement arbitrary operations.

### [3-1. Regarding Generation Index]

Firstly, the explanation is given about an example of the information indicated by the generation index. For example, in the case of training a model in the features of the learning data, the following aspects are believed to contribute to the accuracy of the eventually-obtained model: the manner in which the learning data is input to the model, the state of the model, and the manner of learning of the model (i.e., the features indicated by the hyperparameters). In that regard, the information processing apparatus 10 generates a generation index having the aspects optimized according to the features of the learning data, and enhances the accuracy of the model.

For example, it is believed that the learning data contains data having various labels assigned thereto, that is, data indicating various features. However, when the data that indicates features which are not useful at the time of data classification is treated as the learning data, there is a risk of a decline in the accuracy of the eventually-obtained model. In that regard, as the manner of inputting the learning data to a model, the information processing apparatus 10 decides on the features of the learning data to be input. For example, the information processing apparatus 10 decides which data corresponding to which labels (i.e., which data having which features) is to be input from among the learning data. In other words, the information processing apparatus 10 optimizes the combination of the features to be input.

Meanwhile, the learning data is believed to contain columns of various formats, such as data of only numerical values or data having character strings included therein. At the time of inputting such learning data to a model, it is believed that the accuracy of the model is different when the learning data is input without modification than when the learning data is input after being converted into some other format. For example, when a plurality of types of learning data is present (i.e., when the sets of learning data indicate mutually different features), at the time of inputting the learning data having character strings and the learning data having numerical values, the accuracy of the model is believed to be different in each of the following cases: when the character strings and the numerical values are input without modification; when the character strings are converted into numerical values, and when only numerical values are input; when the numerical values are input by treating them as character strings. In that regard, the information processing apparatus 10 decides on the format of the learning data to be input to the model. For example, the information processing apparatus 10 decides whether to use numerical values or character strings as the learning data to be input to the model. In other words, the information processing apparatus 10 optimizes the column type of the features to be input.

When there are sets of learning data indicating mutually different features, the accuracy of the model is believed to change depending on the combinations of the features that are simultaneously input. That is, when there are sets of learning data indicating mutually different features, the accuracy of the model is believed to change depending on the combinations of the features for training (i.e., depending on the relationship of the combinations of a plurality of features). For example, when a set of learning data indicates a first-type feature (for example, gender), a set of learning data indicates a second-type feature (for example, address), and a set of learning data indicates a third-type feature (for example, purchase history); the accuracy of the model is believed to be different when the learning data indicating the first-type feature and the learning data indicating the second-type feature are simultaneously input than when the learning data indicating the first-type feature and the learning data indicating the third-type feature are simultaneously input. In that regard, the information processing apparatus 10 optimizes the combinations (cross-future) of the features to be used for training the model in the relationship.

In that regard, various models project the input data into spaces that have a predetermined dimensionality and that are divided by a predetermined hyperplane; and classify the input data according to the space, from among the divided spaces, to which the projected position belongs. Hence, if the space into which the input data is projected has a lower dimensionality than the optimum dimensionality, then the classification capability of the input data undergoes a decline, and it results in deterioration in the accuracy of the model. On the other hand, if the space into which the input data is projected has a higher dimensionality than the optimum dimensionality, then the inner product value with the hyperplane undergoes a change, and it could result in a situation in which the data different than the data used during the learning cannot be classified in an appropriate manner. In that regard, the information processing apparatus 10 optimizes the dimensionality of the input data that is to be input to the model. For example, the information processing apparatus 10 controls the node count in the input layer of the model, and optimizes the dimensionality of the input data. In other words, the information processing apparatus 10 optimizes the dimensionality of the space in which the input data is to be embedded.

Meanwhile, as far as models are concerned, in addition to having SVMs, neural networks having a plurality of intermediate layers (hidden layers) are also present. Various types of such neural networks are known, such as a feedback-type DNN in which the information is transmitted in one direction from the input layer to the output layer; a convolutional neural network (CNN) in which convolution of the information is performed in the intermediate layers; a recurrent neural network (RNN) that includes a directed cycle; and a Boltzmann machine. Moreover, in such various types of neural networks, LSTM (Long short-term memory) or other types of neural networks are included.

In this way, when there is a change in the type of the model for learning various features of the learning data, it is believed that the accuracy of the model also changes. In that regard, the information processing apparatus 10 selects the type of the model according to the types of the label assigned as the label of the learning data. As a more specific example, when there is data that is assigned with the terms related to a label “history”, the information processing apparatus 10 selects such an RNN which is believed to enable better learning of the features of the history. On the other hand, when there is data that is assigned with the terms related to a label “image”, the information processing apparatus 10 selects such a CNN which enables better learning of the features of images. Other than that, the information processing apparatus 10 can determine whether or not the label is a prespecified term or a term similar to a prespecified term, and can select the type of model associated in advance to the term determined to be identical or similar to a prespecified term.

Meanwhile, when the number of intermediate layers of a model changes or when the number of nodes included in a single intermediate layer changes, it is believed that the learning accuracy of the model also changes. For example, when a model includes a large number of intermediate layers (i.e., when a model is deep), it is believed that the classification can be done according to more abstract features. However, in backpropagation, since it becomes difficult for the local error to propagate to the input layer, there is a risk that the learning cannot be performed in an appropriate manner. Meanwhile, when only a small number of nodes are included in an intermediate layer, it becomes possible to perform more sophisticated abstraction. However, if the number of nodes is too small, then it is highly likely to result in deficit of the information required for classification. In that regard, the information processing apparatus 10 optimizes the number of intermediate layers and the number of nodes included in an intermediate layer. That is, the information processing apparatus 10 optimizes the architecture of the model.

Moreover, depending on the nodes among which connection is established according to the presence or absence of attention and according to whether or not the nodes included in the model are equipped with autoregression, the accuracy of the nodes is believed to change. In that regard, the information processing apparatus 10 performs network optimization such as whether or not autoregression is to be provided and which nodes are to be connected.

Meanwhile, in the case of learning a model, the following are set as hyperparameters: the optimization method of the model (i.e., the algorithm to be implemented at the time of learning), the dropout rate, the activating function of the nodes, and the unit count. Thus, the accuracy of the model is believed to change also when there is a change in such hyperparameters. In that regard, the information processing apparatus 10 optimizes the manner of learning the model, that is, optimizes the hyperparameters.

Moreover, the accuracy of the model changes also when there is a change in the size of the model (the number of input layers, the number of intermediate layers, the number of output layers, or the number of nodes). In that regard, the information processing apparatus 10 performs optimization also regarding the size of the model.

In this way, the information processing apparatus 10 performs optimization regarding the indexes to be used at the time of generating various models as explained earlier. For example, the information processing apparatus 10 stores, in advance, the conditions corresponding to each index. Such conditions are set, for example, according to the empirical rules such as the accuracy of various models as generated from the learning models in the past. Then, the information processing apparatus 10 determines whether or not the learning data satisfies the conditions and adapts, as generation indexes, the indexes associated in advance to the conditions satisfied or not satisfied by the learning data. As a result, the information processing apparatus 10 becomes able to generate the generation indexes enabling accurate learning of the features of the learning data.

Meanwhile, as explained earlier, when the generation indexes are automatedly generated from the learning data and when the operation of creating a model according to the generation indexes is automatedly performed, the user need not refer to the inside of the learning data and need not determine the type of distribution of the data. As a result, for example, the information processing apparatus 10 enables achieving reduction in the time and efforts required for a data scientist in recognizing the learning data accompanying the creation of a model, and enables preventing damage to the privacy accompanying the recognition of the learning data.

### [3-2. Generation Index According to Data Type]

Given below is the explanation of an example of the conditions meant for generating a generation index. Firstly, the explanation is given about an example of the conditions corresponding to the type of data adapted as the learning data.

For example, the learning data to be used in learning contains integers, floating decimal points, or character strings as data. Hence, when an appropriate model is selected with respect to the input data, the learning accuracy of the model is estimated to go up. In that regard, the information processing apparatus 10 generates a generation index based on whether the learning data contains integers, or contains floating decimal points, or contains character strings.

For example, when the learning data contains integers, the information processing apparatus 10 generates a generation index based on the continuity of the learning data. For example, when the density of the learning data exceeds a predetermined first threshold value, the information processing apparatus 10 considers that the learning data has continuity and generates a generation index based on whether or not the maximum value in the learning data exceeds a predetermined second threshold value. On the other hand, if the density of the learning data is lower than the predetermined first threshold value, then the information processing apparatus 10 considers that the learning data is sparse and generates a generation index based on whether or not the number of unique values included in the learning data exceeds a predetermined third threshold value.

A more specific example is explained below. In the following example, the explanation is given about an exemplary operation of selecting a feature function from the configuration file sent to the model generation server 2 that automatedly generates a model according to AutoML. For example, when the learning data contains integers, the information processing apparatus 10 determines whether or not the density of the learning data exceeds the predetermined first threshold value. For example, the information processing apparatus 10 calculates, as the density, the value obtained by dividing the number of unique values, from among the values included in the learning data, by the value obtained as a result of adding “1” to the maximum value in the learning data.

When the density exceeds the predetermined first threshold value, the information processing apparatus 10 determines that the learning data has continuity and determines whether or not the value obtained by adding “1” to the maximum value in the learning data exceeds the second threshold value. If the value obtained by adding “1” to the maximum value in the learning data exceeds the second threshold value, then the information processing apparatus 10 selects “Categorical_column_with_identity & embedding_column” as the feature function. On the other hand, if the value obtained by adding “1” to the maximum value in the learning data is smaller than the second threshold value, then the information processing apparatus 10 selects “Categorical_column_with_identity” as the feature function.

Meanwhile, if the density is lower than the predetermined first threshold value, then the information processing apparatus 10 determines that the learning data is sparse and determines whether the number of unique values included in the learning data exceeds the predetermined third threshold value. If the number of unique values included in the learning data exceeds the predetermined third threshold value, then the information processing apparatus 10 selects “Categorical_column_with_hash_bucket & embedding_column” as the feature function. On the other hand, if the number of unique values included in the learning data is smaller than the predetermined third threshold value, then the information processing apparatus 10 selects “Categorical_column_with_hash_bucket” as the feature function.

Meanwhile, when the learning data contains character strings, the information processing apparatus 10 generates a generation index based on the number of types of character strings included in the learning data. For example, the information processing apparatus 10 counts the number of unique character strings (the number of unique sets of data) included in the learning data and, if the count is smaller than a predetermined fourth threshold value, selects “categorical_column_with_vocabulary_list” and/or “categorical_column_with_vocabulary_file” as the feature function. However, if the count is greater than the predetermined fourth threshold value but smaller than a fifth threshold value that is greater than the predetermined fourth threshold value, then the information processing apparatus 10 selects “categorical_column_with_vocabulary_file & embedding_column” as the feature function. On the other hand, if the count exceeds the fifth threshold value that is greater than the predetermined fourth threshold value, then the information processing apparatus 10 selects “categorical_column_with_hash_bucket & embedding_column” as the feature function.

When the learning data contains floating decimal points, the information processing apparatus 10 generates a conversion index meant for converting the learning data into input data for the model. For example, the information processing apparatus 10 selects “bucketized_column” or “numeric_column” as the feature function. That is, the information processing apparatus 10 bucketizes (performs grouping of) the learning data and selects whether to input the bucket numbers or to input the actual numerical values. Herein, for example, the information processing apparatus 10 can bucketize the learning data in such a way that the numerical values associated to each bucket are within comparable ranges. For example, the range of numerical values can be associated to each bucket in such a way that the number of sets of learning data classified in each bucket is comparable. Thus, the information processing apparatus 10 can select, as the generation index, either the number of buckets or the range of numerical values associated to the buckets.

Moreover, the information processing apparatus 10 obtains the learning data indicating a plurality of features and generates, as a generation index of the model, a generation index that indicates the features, from among the features of the learning data, in which the model is to be trained. For example, the information processing apparatus 10 decides which learning data corresponding to which label is to be input to the model, and generates a generation index indicating the decided label. Moreover, the information processing apparatus 10 generates, as the generation index of the model, a generation index indicating a plurality of types of learning data, from among the types of learning data, to be used in training the model in the correlation. For example, the information processing apparatus 10 decides on the combination of the labels to be simultaneously input to the model, and generates a generation index indicating the decided combination.

Moreover, the information processing apparatus 10 generates, as a generation index of the model, a generation model indicating the dimensionality of the learning data that is input to the model. For example, the information processing apparatus 10 can decide on the node count in the input layer of the model according to: the number of unique sets of data included in the learning data, the number of labels to be input to the model, the combinations of the number of labels to be input to the model, and the number of buckets.

Furthermore, the information processing apparatus 10 generates, as a generation index of the model, a generation index indicating the type of the model to be trained in the features of the learning data. For example, according to the density or the sparseness of the learning data targeted for learning in the past and according to the details of the labels, the number of labels, and the number of combinations of the labels; the information processing apparatus 10 decides on the type of the model to be generated and generates a generation index indicating the decided type. For example, the information processing apparatus 10 generates a generation index indicating the following as model classes in AutoML: “BaselineClassifier”, “LinearClassifier”, “DNNClassifier”, “DNNLinearCombinedClassifier”, “BoostedTreesClassifier”, “AdaNetClassifier”, “RNNClassifier”, “DNNResNetClassifier”, and “AutoIntClassifier”.

Meanwhile, the information processing apparatus 10 can generate a generation index indicating various independent variables of the model of each class. For example, the information processing apparatus 10 can generate, as a generation index of the model, the number of intermediate layers of the model or the number of nodes included in each layer. Moreover, the information processing apparatus 10 can generate, as a generation index of the model, a generation index indicating the form of connection among the nodes of the model or a generation index indicating the size of the model. Such independent variables are appropriately selected according to whether or not various statistical features of the learning data satisfy predetermined conditions.

Furthermore, the information processing apparatus 10 can generate, as a generation index of a model, a generation index indicating the manner of learning at the time of training the model in the features of the learning data, that is, a generation index indicating hyperparameters. For example, the information processing apparatus 10 can generate a generation index indicating the following settings for the learning using AutoML: “stop_if_no_decrease_hook”, or “stop_if_no_increase_hook”, or “stop_if_higher_hook”, or “stop_if_lower_hook”.

That is, based on the labels of the learning data to be used in learning or based on the features of the actual data, the information processing apparatus 10 generates a generation index indicating the features of the learning data in which the model is to be trained, the form of the model to be generated, and the manner of learning at the time of training the model in the features of the learning data. More specifically, the information processing apparatus 10 generates a configuration file for controlling the generation of a model in AutoML.

### [3-3. Regarding Order of Deciding on Generation Index]

Herein, the information processing apparatus 10 can optimize the various abovementioned indexes either in a simultaneous and parallel way or in an appropriate order. Moreover, the information processing apparatus 10 can keep the order of optimization of the indexes to be variable. That is, the information processing apparatus 10 can receive, from the user, the specification about the sequence of deciding on the features of the learning data in which the model is to be trained, the form of the model to be generated, and the manner of learning at the time of training the model in the features of the learning data; and can decide on the indexes according to the received sequence.

For example, when starting the generation of the generation indexes, the information processing apparatus 10 optimizes the input circumstances such as the features of the learning data to be input and the manner in which the learning data is to be input; and then optimizes the input cross-circumstances such as what combination of features is to be used in the training. Then, the information processing apparatus 10 selects the model and optimizes the model structure. Subsequently, the information processing apparatus 10 optimizes the hyperparameters and ends the generation of the generation indexes.

Herein, in the input circumstance optimization, the information processing apparatus 10 can select and correct various input circumstances such as the features and the manner of input of the learning data to be input; can select new input circumstances using a genetic-based algorithm; and can repeatedly optimize the input circumferences. In an identical manner, in the input cross-circumstance optimization, the information processing apparatus 10 can repeatedly optimize the input cross-circumstances, and can repeatedly optimize model selection and the model structure. Moreover, the information processing apparatus 10 can repeatedly optimize the hyperparameters. Furthermore, the information processing apparatus 10 can repeatedly perform the sequence of operations that include input circumstance optimization, input cross-circumstance optimization, model selection, model structure optimization, and hyperparameter optimization; and can accordingly optimize the indexes.

Meanwhile, for example, the information processing apparatus 10 can optimize the hyperparameters and then perform model selection and model structure optimization. After performing model selection and model structure optimization, the information processing apparatus 10 can optimize the input circumstances and the input cross-circumstances. Moreover, for example, the information processing apparatus 10 repeatedly performs input circumstance optimization and then repeatedly performs input cross-circumstance optimization. Subsequently, the information processing apparatus 10 can repeatedly perform input circumstance optimization and input cross-circumstance optimization. In this way, regarding the sequence of optimizing the indexes and regarding the optimization operation to be repeated during optimization, it becomes possible to adapt arbitrary settings.

### [3-4. Regarding Flow of Model Generation as Implemented in Information Processing Apparatus]

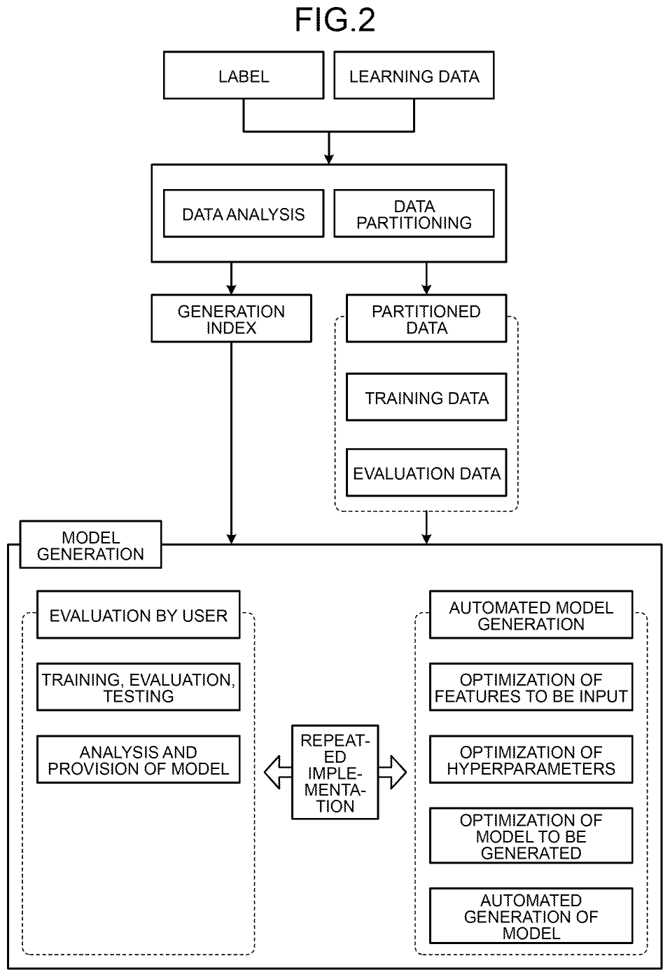

Explained below with reference to FIG. 2 is an exemplary flow of model generation performed using the information processing apparatus 10. FIG. 2 is a diagram for explaining an exemplary flow of model generation performed using the information processing apparatus according to the embodiment. For example, the information processing apparatus 10 receives sets of learning data and receives the label assigned to each set of learning data. Alternatively, the information processing apparatus 10 can receive the specification of the learning data and can receive the labels.

In that case, the information processing apparatus 10 analyzes the data and partitions it according to the analysis result. For example, the information processing apparatus 10 partitions the learning data into training data to be used in the learning of the model and evaluation data to be used in the evaluation of the model (i.e., the measurement of the accuracy). Meanwhile, the information processing apparatus 10 can further partition data meant for various tests. The operation of partitioning the learning data into the training data and the evaluation data can be performed using an arbitrary known technology.

Moreover, the information processing apparatus 10 uses the learning data and generates various generation indexes. For example, the information processing apparatus 10 generates a configuration file for defining the model generated in AutoML and defining the learning of the model. In such a configuration file, various functions used in AutoML are stored without modification as the information indicating the generation indexes. Then, the information processing apparatus 10 provides the training data and the generation indexes to the model generation server 2, and implements model generation.

Herein, on account of repeated user evaluation of the model and repeated automated generation of the model, the information processing apparatus 10 can achieve optimization of the generation indexes and in turn achieve optimization of the model. For example, the information processing apparatus 10 optimizes the features to be input (i.e., optimizes the input circumstances and the input cross-circumstances), optimizes the hyperparameters, and optimizes the model to be generated; and implements automated model generation according to the optimized generation indexes. Then, the information processing apparatus 10 provides the generated model to the user.

Meanwhile, the user performs training, evaluation, and testing of the automatedly-generated model, and analyzes and provides the model. Moreover, the user corrects the generated generation indexes, ensures that a new model is again automatedly generated, and performs evaluation and testing. As a result of performing such operations in a repeated manner, the operations for enhancing the accuracy of the model can be performed through a trial and error process and without having to perform complex operations.

### 4. Configuration of Information Processing Apparatus

Explained below with reference to FIG. 3 is an exemplary functional configuration of the information processing apparatus 10 according to the embodiment. FIG. 3 is a diagram illustrating an exemplary configuration of the information processing apparatus according to the embodiment. As illustrated in FIG. 3, the information processing apparatus 10 includes a communication unit 20, a memory unit 30, and a control unit 40.

The communication unit 20 is implemented using, for example, a network interface card (NIC). Then, the communication unit 20 is connected to the network N in a wired manner or a wireless manner, and communicates information with the model generation server 2 and the terminal device 3.

The memory unit 30 is implemented using a semiconductor memory device such as a RAM (Random Access Memory) or a flash memory, or using a memory device such as a hard disk or an optical disc. The memory unit 30 includes a learning data database 31 and a model generation database 32.

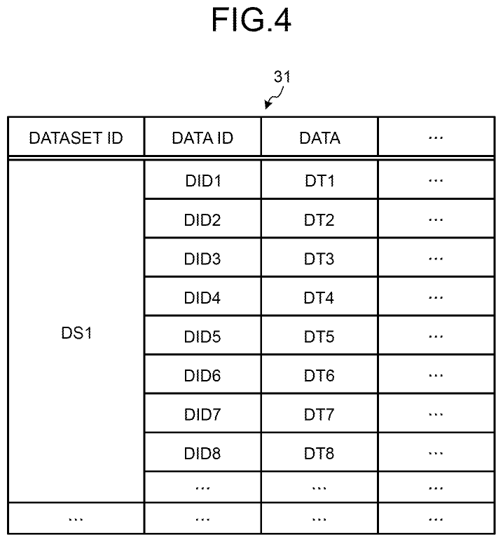

The learning data database 31 is used to store a variety of information related to the data to be used in learning. Thus, the learning data database 31 is used to store datasets of learning data to be used in the learning of models. FIG. 4 is a diagram illustrating an example of the information registered in the learning data database according to the embodiment. In the example illustrated in FIG. 4, the learning data database 31 includes the following items: “dataset ID”, “data ID”, and “data”.

The item “dataset ID” represents the identification information enabling identification of the concerned dataset. The item “data ID” represents the identification information enabling identification of the concerned sets of data. The item “data” represents the data identified by the corresponding data IDs. For example, in the example illustrated in FIG. 4, with respect to each data ID that enables identification of a set of learning data, the corresponding data (learning data) is registered in a corresponding manner.

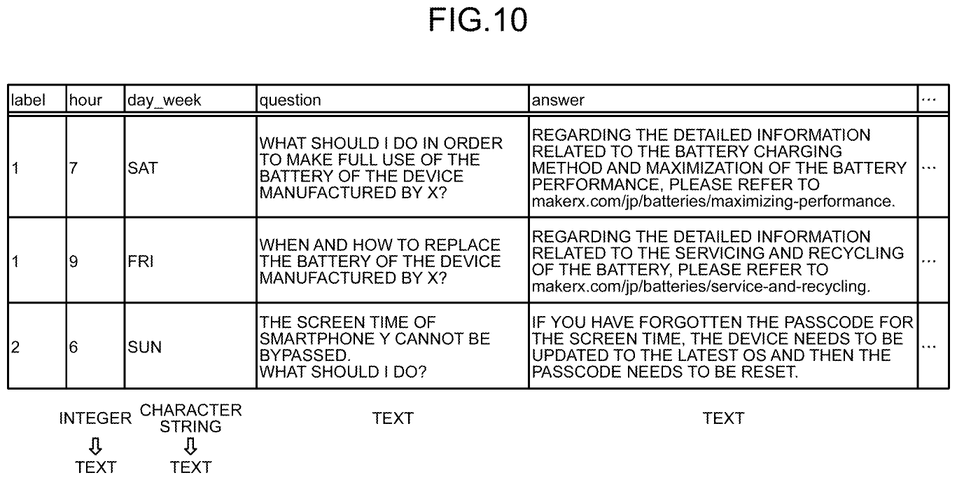

In the example illustrated in FIG. 4, it is indicated that, the dataset identified by a dataset ID “DS1” (i.e., a dataset DS1) includes a plurality of sets of data such as “DT1”, “DT2”, “DT3”, and so on identified by data IDs “DID1”, “DID2”, “DID3”, and so on. Meanwhile, in FIG. 4, the sets of data are indicated using abstract character strings such as “DT1”, “DT2”, “DT3”, and so on. However, as far as the data is concerned, for example, information in an arbitrary format such as integers, real numbers, character strings, or sentences can be registered; or the information obtained by conversion, into a text, of information in an arbitrary format such as integers, real numbers, character strings, or sentences can be registered. For example, in the learning data database 31, data illustrated in FIG. 10 can be stored.

Meanwhile, although not illustrated in FIG. 4, the learning data database 31 can be used to store labels (correct solution information), which correspond to the sets of data, in a corresponding manner to the sets of data. Moreover, for example, a single label can be stored in a corresponding manner to a data constellation containing a plurality of sets of data. In that case, the data constellation containing a plurality of sets of data corresponds to the data to be input to a model (i.e., corresponds to input data). As far as a label is concerned, for example, information in an arbitrary format such as a numerical value or a character string can be used.

Meanwhile, the learning data database 31 is not limited to the explanation given above, and can also be used to store a variety of information according to the objective. For example, the learning data database 31 is used to store, in a corresponding manner to each set of data, information indicating the learning stage from among a plurality of learning stages in which the concerned set of data is to be used. For example, the learning data database 31 is used to store, in a corresponding manner to each set of data, information indicating whether the concerned set of data belongs to a first-type data constellation or a second-type data constellation. For example, in the learning data database 31, each set of data can be stored in such a way that whether the concerned set of data is the data for use in the learning operation (i.e., training data) or is the data for use in evaluation (i.e., evaluation data) can be identified. For example, in the learning data database 31, information (such as a flag) enabling identification of whether each set of data represents the training data or the evaluation data can be stored in a corresponding manner to the concerned set of data.

The model generation database 32 is used to store a variety of information, other than the learning data, to be used in generating a model. The model generation database 32 is used to store a variety of information related to the generation of a model. For example, the model generation database 32 is used to store information that is to be used in generating a model according to a genetic-based algorithm. For example, the model generation database 32 is used to store information that, based on a genetic-based algorithm, specifies the number of types of combinations to be carried over for the subsequent operations.

For example, the model generation database 32 is used to store setting values of various parameters related to the generation of a model. The model generation database 32 is used to store the upper limit value of the size of a model (also called “size upper limit value”). Moreover, the model generation database 32 is used to store information indicating the structure of a model, such as the number of partial models (blocks) included in a model to be generated and information related to each partial model. Furthermore, the model generation database 32 is used to store information related to the modules that are used as the constituent elements of a partial model. A partial model (block) can constitute, for example, some part of a model, or can itself function as a single model. A module is, for example, an element representing a functional unit meant for implementing a function of a partial model (block).

The model generation database 32 is used to store information indicating the type of operations performed by each module and information related to the constituent elements of each module. Thus, the model generation database 32 is used to store a variety of information related to the operations constituting each module. That is, the model generation database 32 is used to store information related to the operations such as normalization and dropout that constitute each module.

For example, the model generation database 32 is used to store information related each partial model. Thus, the model generation database is used to store information indicating the types of modules constituting each partial model. For example, the model generation database is used to store information indicating the number of modules included in each partial model. Thus, the model generation database is used to store information indicating the modules included in each partial model.

The model generation database 32 is used to store information indicating the types of data used as the input by each partial model. For example, the model generation database 32 is used to store information indicating the combinations of the types of data used as the input by each partial model.

Meanwhile, the model generation database 32 is not limited to store the information mentioned above, and can also be used to store a variety of information as long as it is to be used in generating a model.

Returning to the explanation with reference to FIG. 3, the control unit 40 is implemented when, for example, a CPU (Central Processing Unit) or an MPU (Micro Processing Unit) executes various programs (for example, a generation program written for performing the operation of generating a model, and an information processing program), which are stored in the internal storage device of the information processing apparatus 10, while using the RAM as the work area. The information processing program causes a computer to operate as a model that includes at least one partial model (block). For example, the information processing program causes a computer to operate as a model that is learnt using the learning data (for example, to operate as the information processing apparatus 10). Meanwhile, for example, the control unit 40 can alternatively be implemented using an integrated circuit such as an ASIC (Application Specific Integrated Circuit) or an FPGA (Field Programmable Gate Array). As illustrated in FIG. 3, the control unit 40 includes an obtaining unit 41, a deciding unit 42, a receiving unit 43, a generating unit 44, a processing unit 45, and a providing unit 46.

The obtaining unit 41 obtains information from the memory unit 30. The obtaining unit 41 obtains the datasets of the learning data to be used in the learning of a model. Thus, the obtaining unit 41 obtains the learning data to be used in the learning of a model. For example, when a variety of data to be used as the learning data and the labels assigned to the variety of data are received from the terminal device 3, the obtaining unit 41 registers the data and the labels as learning data in the learning data database 31. Moreover, from among the data registered in advance in the learning data database 31, the obtaining unit 41 can receive the specification of the learning data IDs and the labels of the learning data to be used in the learning of a model.

Moreover, the obtaining unit 41 obtains the learning data to be used in the learning of a model that treats, as the input, a plurality of sets of input information containing post-conversion information obtained by conversion of information other than texts including a sentence text. Furthermore, the obtaining unit 41 obtains the learning data to be used in the learning of a model that treats, as the input, a plurality of texts including texts obtained by conversion of information other than sentences. Moreover, the obtaining unit 41 obtains the learning data to be used in the learning of a model that treats, as the input, a plurality of texts including texts obtained by conversion of information other than a sentence text (hereinafter, also called sentence) representing a sentence. Furthermore, the obtaining unit 41 obtains the learning data to be used in the learning of a model that treats, as the input, a plurality of texts obtained by conversion, into a text, of tabular data containing information other than sentences.

Moreover, the obtaining unit 41 obtains the learning data to be used in the learning of a model that treats, as the input, a plurality of texts including texts corresponding to sentences. Furthermore, the obtaining unit 41 obtains the learning data to be used in the learning of a model that treats, as the input, a plurality of texts including sentence texts. Moreover, the obtaining unit 41 obtains the learning data to be used in the learning of a model that treats, as the input, a plurality of texts including texts corresponding to sentences posted on the Internet. Furthermore, the obtaining unit 41 obtains the learning data to be used in the learning of a model that treats, as the input, a plurality of texts including sentence texts posted on the Internet. Moreover, the obtaining unit 41 obtains the learning data to be used in the learning of a model that treats, as the input, a plurality of texts including texts corresponding to questions posted on the Internet. Furthermore, the obtaining unit 41 obtains the learning data to be used in the learning of a model that treats, as the input, a plurality of texts including texts corresponding to answers posted on the Internet.

Moreover, the obtaining unit 41 obtains the learning data to be used in the learning of a model that treats, as the input, a plurality of texts including texts obtained by conversion of numerical values. Furthermore, the obtaining unit 41 obtains the learning data to be used in the learning of a model that treats, as the input, a plurality of texts including texts obtained by conversion of integers. Moreover, the obtaining unit 41 obtains the learning data to be used in the learning of a model that treats, as the input, a plurality of texts including texts obtained by conversion of real numbers. Furthermore, the obtaining unit 41 obtains the learning data to be used in the learning of a model that treats, as the input, a plurality of texts including texts obtained by conversion of numerical values indicating the date and time at which sentences were posted.

Moreover, the obtaining unit 41 obtains the learning data to be used in the learning of a model that treats, as the input, a plurality of texts including texts obtained by conversion of character strings other than sentences. Furthermore, the obtaining unit 41 obtains the learning data to be used in the learning of a model that treats, as the input, a plurality of texts including texts obtained by conversion of character strings indicating the days of week on which sentences were posted.

Moreover, the obtaining unit 41 obtains the learning data to be used in the learning of a base model that treats texts as the input. Herein, the base model can be a model (partial model) learnt in such a way that it can be used as part of models having various usages, for example, can be used in executing a wide variety of tasks. For example, the base model can be a model implementable as the base (partial model) of a wide variety of applications. Furthermore, the obtaining unit 41 obtains the learning data that contains the first-type data constellation to be used in the learning of the general-purpose language capacity. The obtaining unit 41 obtains the first-type data constellation containing natural language data to be used in the learning of a large-scale language model.

Moreover, the obtaining unit 41 obtains the learning data that contains the second-type data constellation to be used in the learning of the language capacity meant for specific processing. The obtaining unit 41 obtains the learning data containing the second-type data constellation that represents data related to the postings on the Internet. Moreover, the obtaining unit 41 obtains the second-type data constellation that contains texts corresponding to questions posted on the Internet. Furthermore, the obtaining unit 41 obtains the second-type data constellation that contains texts corresponding to answers posted on the Internet.

The deciding unit 42 decides on a variety of information related to the learning operation. The deciding unit 42 decides on the manner of learning. Moreover, the deciding unit 42 decides on the initial values in the learning operation to be performed by the generating unit 44. Furthermore, the deciding unit 42 decides on the initial values of various parameters. The deciding unit 42 refers to a setting file indicating the values of the initial setting of various parameters, and accordingly decides on the initial values of various parameters. For example, the deciding unit 42 decides on the maximum number of partial models (blocks) that can be included in a model. Moreover, the deciding unit 42 decides on the maximum number of modules that can be included in a partial model (block). Furthermore, the deciding unit 42 decides on the dropout rate. Herein, the deciding unit 42 decides on the dropout rate for each partial model (block). Moreover, the deciding unit 42 decides on the size of the model. Furthermore, the deciding unit 42 decides on the number of modules to be included in each partial model (block).

The receiving unit 43 receives corrections in the generation indexes that are presented to the user. Moreover, the receiving unit 43 receives, from the user, the specification about the sequence in which the following is to be decided: the features of the learning data in which the model is to be trained, the form of the model to be generated, and the manner of learning at the time of training the model in the features of the learning data.

The generating unit 44 generates a variety of information according to the decisions made by the deciding unit 42. Moreover, the generating unit 44 generates a variety of information according to the instructions received by the receiving unit 43. For example, the generating unit 44 can generate the generation indexes of a model.

Furthermore, the generating unit 44 performs learning using the learning data and generates a model to which information other than sentences can be input in the form of a text. Moreover, the generating unit 44 generates a model that treats, as the input, a plurality of texts based on tabular data. Furthermore, the generating unit 44 performs learning using the learning data and generates a model representing a language model to which information other than sentences can be input in the form of a text.

Moreover, the generating unit 44 generates a model that treats, as the input, a plurality of texts including texts corresponding to sentences. Furthermore, the generating unit 44 generates a model that treats, as the input, a plurality of texts including sentence texts. Moreover, the generating unit 44 generates a model that treats, as the input, a plurality of texts including texts corresponding to questions. Furthermore, the generating unit 44 generates a model that treats, as the input, a plurality of texts including texts corresponding to answers.

Moreover, the generating unit 44 generates a model to which numerical values can be input in the form of a text. Furthermore, the generating unit 44 generates a model to which integers can be input in the form of a text. Moreover, the generating unit 44 generates a model to which real numbers can be input in the form of a text. Furthermore, the generating unit 44 generates a model to which the date and time of posted sentences can be input in the form of a text. Moreover, the generating unit 44 generates a model to which character strings other than sentences can be input in the form of a text. Furthermore, the generating unit 44 generates a model to which the days of week on which sentences were posted can be input in the form of a text.

Moreover, the generating unit 44 generates a base model according to a multistage learning operation in which the learning data is used. Thus, the generating unit 44 generates a base model according to a multistage learning operation that includes a first-stage learning operation in which the first-type data constellation is used. Moreover, the generating unit 44 generates a base model according to a multistage learning operation that includes a second-stage learning operation in which the second-type data constellation is used.

Furthermore, the generating unit 44 generates a base model according to a multistage learning operation that includes a third-stage learning operation in which learning is performed by increasing the layers of the base model. Herein, the generating unit 44 generates a base model according to the third-stage learning operation that makes use of the data used for learning the language capacity meant for specific processing. The generating unit 44 generates a base model according to the third-stage learning operation that makes use of the data related to the postings on the Internet.

Moreover, the generating unit 44 generates a base model according to the third-stage learning operation that makes use of the texts corresponding to the sentences posted on the Internet. As a result of performing the third-stage learning operation in a repeated manner, the generating unit 44 performs the operation of increasing the layers of the base model, performs the learning operation with respect to the base model having an increased number of layers, and generates a base model.

Moreover, the generating unit 44 performs learning using the learning data and generates a model to which information other than sentence texts can be input upon conversion. Furthermore, the generating unit 44 performs learning using information other than sentences, and generates a base model and generates a fine-tuned model obtained by fine-tuning the base model to be applicable to a predetermined task. Moreover, the generating unit 44 generates a base model and generates a fine-tuned model that has a different input of the input information than the base model. Furthermore, the generating unit 44 generates a base model and generates a fine-tuned model that has the same order of input of the input information as the base model. The generating unit 44 uses label information as the input information at the time of learning of the base model.

The generating unit 44 can generate a model also based on a genetic-based algorithm. For example, the generating unit 44 generates a plurality of models with respect to a plurality of combination candidates in each of which the combination of types is different. Then, from among the generated plurality of models, using combination candidates (also called “carry-over candidates) corresponding to a predetermined number of (for example, two) models having high accuracy, the generating unit 44 can further generate a model. For example, from among the carry-over candidates, the generating unit 44 can carry over some combinations of types and can generate a model using the candidates of types in which the combinations of types of the carry-over candidates are copied. The generating unit 44 can repeatedly perform the operation of carrying over the combinations of types of the carry-over candidates and generating a model, and thus generate a model that is to be eventually used.

Then, the generating unit 44 sends the data, which is to be used in generating a model, to the model generation server 2 that is an external server; and requests the model generation server 2 to learn a model. Subsequently, the generating unit 44 generates a model by receiving, from the model generation server 2, the model learnt by the model generation server 2.

For example, the generating unit 44 generates a model using the data registered in the learning data database 31. Thus, the generating unit 44 generates a model based on a variety of data and labels used as the training data. The generating unit 44 generates a model by performing learning in such a way that the output result which is output by the model in response to the input of the training data matches with the labels. For example, the generating unit 44 sends, to the model generation server 2, a variety of data and labels used as the training data; and generates a model by causing the model generation server 2 to learn about the model.

For example, the generating unit 44 measures the accuracy of a model using the data registered in the learning data database 31. Thus, the generating unit 44 measures the accuracy of a model based on a variety of data and labels used as the evaluation data. The generating unit 44 measures the accuracy of a model by collecting the result of comparison of the output result, which is output by the model in response to the input of the evaluation data, with the labels.

The processing unit 45 performs a variety of processing. The processing unit 45 functions as an inferring unit that performs an inference operation. The processing unit 45 performs the inference operation using a model stored in the memory unit 30 (for example, the model M1). Moreover, the processing unit 45 performs inferencing using the model obtained by the obtaining unit 41. Furthermore, the processing unit 45 performs inferencing using the model generated by the generating unit 44. Moreover, the processing unit 45 performs inferencing using the model learnt with the use of the model generation server 2. The processing unit 45 inputs data to a model and performs the inference operation for generating the inference result corresponding to the input data.

The processing unit 45 performs the inference operation using the model generated by the generating unit 44. The processing unit 45 inputs a plurality of texts, which includes texts obtained by conversion of information other than sentences, to the model and performs the inference operation based on the output data that is output by the model. Moreover, the processing unit 45 inputs a plurality of texts, which includes texts obtained by conversion of information other than sentence texts representing sentences, to the model and performs the inference operation based on the output data that is output by the model. Furthermore, the processing unit 45 inputs a plurality of texts, which includes texts obtained by conversion of at least either integers, or real numbers, or character strings, to the model and performs the inference operation based on the output data that is output by the model.

The processing unit 45 can perform the inference operation using an external device (an inference server) that includes models. For example, the processing unit 45 can send the input data to an inference server including models; receive information (inference information) generated by the external device using the input data and a model; and perform the inference operation using the inference information.

The providing unit 46 provides the generated model to the user. The providing unit 46 sends, to the terminal device 3 of the user, an information processing program that causes the terminal device 3 of the user to operate as a model (for example, the model M1) which is to be used in the inference operation. For example, when the accuracy of the model generated by the generating unit 44 exceeds a predetermined threshold value, the providing unit 46 sends that model and the generation indexes corresponding to that model to the terminal device 3. As a result, the user becomes able to evaluate and try out the model, and to correct the generation indexes.

The providing unit 46 provides, to the user, the indexes generated by the generating unit 44. For example, the providing unit 46 sends the configuration file, which is generated in AutoML and represents the generated indexes, to the terminal device 3. Meanwhile, every time a generation index is generated, the providing unit 46 can provide that generation index to the user. Alternatively, for example, only those generation indexes which correspond to a model having the accuracy exceeding a predetermined threshold value can be presented to the user.

### 5. Operation Flow of Information Processing System

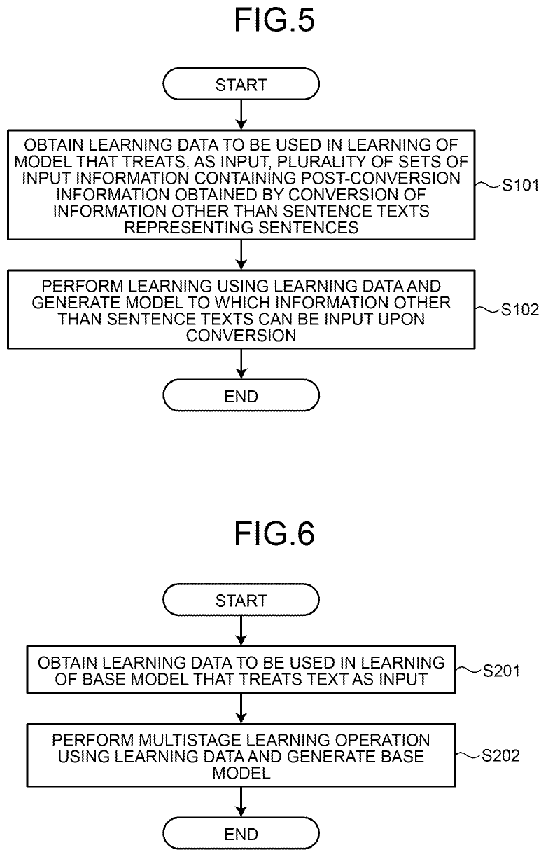

Explained below with reference to FIGS. 5 and 6 is a sequence of operations performed in the information processing apparatus 10. FIGS. 5 and 6 are flowcharts for explaining an exemplary flow of information processing performed according to the embodiment. The following explanation is given about the case in which the operations are performed in the information processing system 1. However, alternatively, the operations explained below can be performed in any individual device included in the information processing system 1, such as the information processing apparatus 10, the model generation server 2, or the terminal device 3 included in the information processing system 1.

Firstly, the explanation is given about the example of operations illustrated in FIG. 5. With reference to FIG. 5, the information processing system 1 obtains learning data to be used in the learning of a model that treats, as the input, a plurality of sets of input information containing post-conversion information obtained by conversion of information other than sentence texts representing sentences (Step S101). Then, the information processing system 1 performs learning using the learning data and generates a model to which information other than sentence texts can be input upon conversion (Step S102).

The following explanation is given about the example of operations illustrated in FIG. 6. With reference to FIG. 6, the information processing system 1 obtains learning data to be used in the learning of a base model that treats a text as the input (Step S201). Then, the information processing system 1 performs a multistage learning operation using the learning data and generates a base model (Step S202).

### 6. Example of Operations Performed in Information Processing System

Given below is the explanation of an example in which the operations illustrated in FIGS. 5 and 6 are performed in the information processing system 1. The information processing apparatus 10 obtains learning data. Moreover, the information processing apparatus 10 obtains information such as the parameters to be used in the generation of a model. For example, the information processing apparatus 10 obtains information indicating various upper limit values regarding the model to be generated. For example, the information processing apparatus 10 obtains information indicating the size upper limit value of the model to be generated. Moreover, the information processing apparatus 10 obtains various setting values in a genetic-based algorithm. For example, the information processing apparatus 10 obtains information indicating the number of carry-over candidates in a genetic-based algorithm.

The information processing apparatus 10 generates a model based on: the learning data, the information indicating the structure of the model, the various upper limit values such as the size upper limit value, and the information indicating the setting values in a genetic-based algorithm. The information processing apparatus 10 generates the model to which information other than sentence texts can be input upon conversion. Moreover, the information processing apparatus 10 learns a model that treats, as the input, a plurality of sets of input information containing post-conversion information obtained by conversion of information other than sentence texts representing sentences. For example, the information processing apparatus 10 generates a model to which information other than sentences can be input in the form of a text. Furthermore, the information processing apparatus 10 performs a multistage learning operation using the learning data and generates a base model.

The information processing apparatus 10 sends, to the model generation server 2 that learns a model, the information to be used in generating a model. For example, the information processing apparatus 10 sends the following information to the model generation server 2: the learning data, the information indicating the structure of the model, the various upper limit values such as the size upper limit value, and the information indicating the setting values in the genetic-based algorithm.

Upon receiving the information from the information processing apparatus 10, the model generation server 2 generates a model according to the learning operation. Then, the model generation server 2 sends the generated model to the information processing apparatus 10. In this way, the term “generating a model” according to the application concerned is a concept not limited to the case in which a model is learnt in the concerned apparatus but also includes providing necessary information for model generation to another device, instructing the other device to generate a model, and receiving the model learnt by the other device. In the information processing system 1, the information processing apparatus 10 sends, to the model generation server 2 that learns a model, the information to be used in generating a model; and generates a model by obtaining the model generated by the model generation server 2. In this way, the information processing apparatus 10 generates a model by sending the information to be used in generating a model to another device, requesting the other device to generate a model, and causing the other device that received the request to generate the model.

### 7. Model

Given below is the explanation of a model. The following explanation is given about various points related to a model, such as the structure of a model and the manner of learning a model, generated in the information processing system 1. In the example given below, a text obtained by conversion of information other than sentence texts representing sentences is explained as an example of post-conversion information. Meanwhile, neither the format of the post-conversion information is limited to a text, nor the input to a model is limited to a text. Regarding that point, the explanation is given later.

### [7-1. Exemplary Structure of Model]

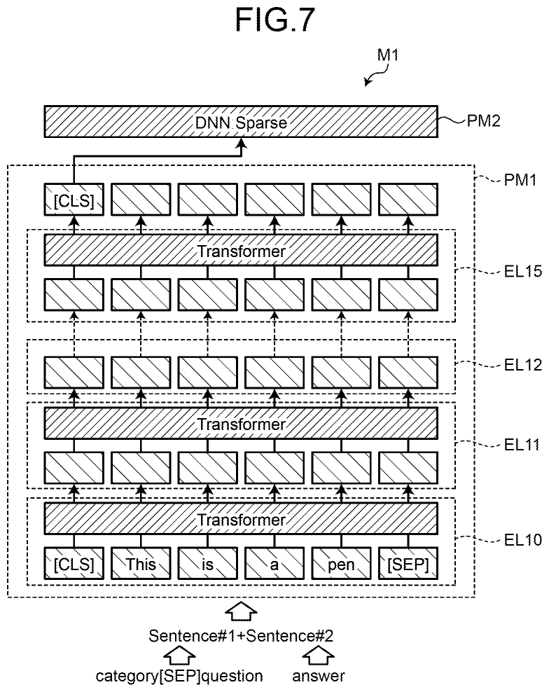

Firstly, explained below with reference to FIG. 7 is an exemplary structure of a model to be generated. The information processing system 1 generates the model M1 as illustrated in FIG. 7. Thus, FIG. 7 is a diagram illustrating an exemplary structure of a model according to the embodiment. In FIG. 7, the information processing system 1 generates the model M1 that includes various configurations such as a plurality of partial models, such as a partial model PM1 representing an example of a base model and a partial model PM2 in which the output of the partial model PM1 is used as the input. When the partial models PM1 and PM2 need not be distinguished from each other, they are sometimes referred to as “partial models PM” or simply “partial models”. Meanwhile, in FIG. 7, the model M1 is illustrated to include two partial models PM. However, alternatively, the model M1 can include three or more partial models PM, or can include only one partial model PM.

For example, the partial model PM1 is a model (language model) based on transformers. Herein, a transformer (model) is identical to a conventional transformer, and its detailed explanation is not given. Meanwhile, as long as information such as integers and real numbers can be input in a format (text) identical to sentences (also simply called “statements”), the partial model PM1 can be any type of model. For example, the partial model PM1 can be configured based on an arbitrary natural language processing models such as BERT (Bidirectional Encoder Representations from Transformers), ROBERTa (A Robustly Optimized BERT Pretraining Approach), a DeBERTa (Decoding-enhanced BERT with disentangled attention). Moreover, as long as information such as integers and real numbers can be input in a format (text) identical to sentences, the partial model PM1 is not limited to be configured based on BERT, and can have an arbitrary configuration.

In the example illustrated in FIG. 7, the partial model PM1 includes a plurality of layers (module layers) EL10, EL11, EL12, . . . , EL15. In the following explanation, when the layers EL10, EL11, EL12, . . . , EL15 need not be particularly distinguished from each other, they are sometimes referred to as “layers EL” or simply as “layers”. In FIG. 7, an exemplary configuration is illustrated in which each layer EL includes a single transformer. Meanwhile, the number of layers illustrated in FIG. 7 is only exemplary, and the partial model PM1 can be configured to include an arbitrary number or layers EL. Moreover, the number of layers EL in the partial model PM1 can be varied (increased) according to the learning. Regarding that point, the explanation is given later.

In FIG. 7, the layer EL10 is positioned closest to the input side of the partial model PM1. For example, the layer EL10 can represent the layer (input layer) to which the input data for the partial model PM1 is input. In FIG. 7 is illustrated an exemplary state in which the following is input to (the layer EL10 of) the partial model PM1: a token “CLS” indicating the start of a text (sentence); a text “This is a pen”; and a token “SEP” indicating a separator in a sentence. For example, the token “SEP” if followed by the input such as the information obtained by conversion, into a text, of a numerical value (integer) indicating the time (for example, the character “7”), or the information obtained by conversion, into a text, of a character string indicating the day of the week (for example, characters “Sat”) is input.

In the partial model PM1, the layer EL11 is placed after the layer EL10. That is, the layer EL11 represents the layer to which the output of the layer EL10 is input. Moreover, in the partial model PM1, the layer EL12 is placed after the layer EL11. That is, the layer EL12 represents the layer to which the output of the layer EL11 is input.

In FIG. 7, the layer EL15 is positioned closest to the output side of the partial model PM1. For example, the output of the layer EL15 is used as the output of the partial model PM1. Meanwhile, the partial model PM1 illustrated in FIG. 7 is only exemplary, and can have an arbitrary configuration.

In FIG. 7, the partial model PM2 having “DNN Sparse” written therein represents the partial model in which the output of the partial model PM1 is used as the input. For example, the partial model PM2 is a sparse DNN (deep neural network) configured using an arbitrary technology such as dropout. Meanwhile, as long as the output from the partial model PM1 is used as the input and the desired inference result represents the output, the partial model PM2 can be any type of model. For example, the partial model PM2 is not limited to a sparse DNN, and can alternatively be an arbitrary DNN. Moreover, the partial model PM2 is not limited to a DNN, and can be an arbitrary model.

### [7-2. Example of Input to Model]

In FIG. 7 is illustrated an example of the input given to the model M1. In FIG. 7 is illustrated an example in which two sentences Sentence #1 and Sentence #2 are input to the model M1. For example, in the model M1 illustrated in FIG. 7, as the sentence Sentence #1, a text is input in which the following information is arranged in the given order: the information obtained by conversion, into a text, of the information indicating the category of a question; the token “SEP”; and a text corresponding to the question (question sentence). That is, in FIG. 7, as the sentence Sentence #1, a single text is used in which the information obtained by conversion, into a text, of information indicating the category of a question is concatenated to the text corresponding to the question using the token “SEP”.

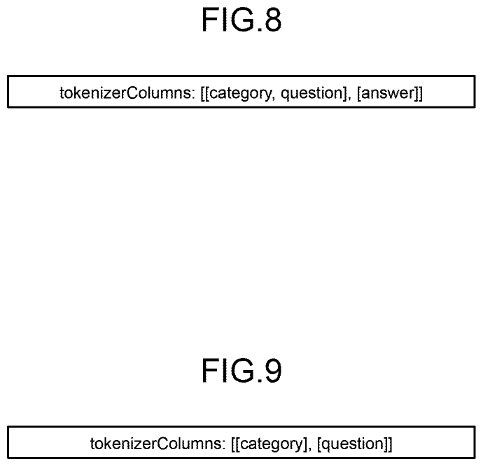

Moreover, in the model M1 illustrated in FIG. 7, the text corresponding to an answer (answer sentence) is input as the sentence Sentence #2. That is, in FIG. 7, the text corresponding to an answer is used in the sentence Sentence #2. In FIG. 8 is illustrated an example of the specification of the input illustrated in FIG. 7. FIG. 8 is a diagram illustrating an example of the specification of the input to a model according to the embodiment. As illustrated in FIG. 8, the input to the model M1 is performed when column (item) names corresponding to various types of information are specified.

For example, when a category and a question are specified as the sentence Sentence #1 representing the input to the model M1, a character string is used in which character strings indicating various types are separated by separating characters (commas in the example illustrated in FIG. 8) and are parenthesized in a square bracket. More particularly, a character string “[category, question]” is used as the specification of the sentence Sentence #1.

Meanwhile, when an answer is to be specified as the sentence Sentence #2 representing the input to the model M1, a character string is used in which a character string indicating the input type is parenthesized in a square bracket. More particularly, a character string “[answer]” is used as the specification of the sentence Sentence #2.

In the example illustrated in FIG. 8, as the overall input to the model M1, a character string is used in which the information of various types such as the sentences Sentence #1 and Sentence #2 is separated by separating characters (commas in the example illustrated in FIG. 8). More particularly, a character string “tokenizerColumns: [[category, question], [answer]]” is used as the specification of the input to the model M1.

Meanwhile, the specification illustrated in FIG. 8 is only exemplary; and, as long as the input to the model M1 can be specified, the specification can be in an arbitrary form. Moreover, the input illustrated in FIG. 7 is also only exemplary; and, as long as a text is used, an arbitrary combination can be used as the input to the model M1. For example, when a question and an answer are used as the input to the model M1, it is possible to use the specification as illustrated in FIG. 9. FIG. 9 is a diagram illustrating an example of the specification of the input to a model according to the embodiment. As illustrated in FIG. 9, as the input to the model M1, when a question is specified as the sentence Sentence #1 and an answer is specified as the sentence Sentence #2, a character string “tokenizerColumns: [[question], [answer]]” is used.

As explained earlier, information other than sentences is also converted into a text and is input to the model M1. Regarding that example, the explanation is given below with reference to FIG. 10. FIG. 10 is a diagram illustrating an example of the types of the input according to the embodiment. In FIG. 10, each row indicates the type of information included in the concerned data. Meanwhile, the information corresponding to “label” illustrated in FIG. 10 need not be a part of the input to a model. For example, the information corresponding to “label” illustrated in FIG. 10 can represent a label (correct solution information) indicating whether or not the question or the answer specified in each row falls under a violation.

For example, the information corresponding to “hour” illustrated in FIG. 10 represents an integer (a numerical value) indicating the date and time at which the question or the answer in the concerned row was posted. When the information corresponding to “hour” illustrated in FIG. 10 is to be used as the input to the model M1, the concerned integer (numerical value) is input upon conversion into a text.

Furthermore, for example, the information corresponding to “day_week” illustrated in FIG. 10 represents a character string indicating the day of the week on which the question or the answer in the concerned row was posted. When the information corresponding “day_week” illustrated in FIG. 10 is to be used as the input to the model M1, the concerned character string is input upon conversion into a text. As a result, integers, real numbers, and character strings too can be input as texts to the model M1. Meanwhile, when a character string indicating the day of the week can be used without modification as a text, the information corresponding to “day_week” illustrated in FIG. 10 can be used without modification as the input to the model M1.

Moreover, for example, the information corresponding to “question” illustrated in FIG. 10 represents a sentence indicating the question in the concerned row. When the information corresponding to “question” illustrated in FIG. 10 is to be used as the input to the model M1, the concerned sentence (text) is used without modification as the input to the model M1.

Furthermore, for example, the information corresponding to “answer” illustrated in FIG. 10 represents a sentence indicating the answer in the concerned row. When the information corresponding to “answer” illustrated in FIG. 10 is to be used as the input to the model M1, the concerned sentence (text) is used without modification as the input to the model M1. Meanwhile, the types of information illustrated in FIG. 10 are only exemplary. That is, the types of information that can be used as the input to the model M1 are not limited to the types illustrated in FIG. 10. For example, the types of information to be used as the input to the model M1 can include the type “category” as explained earlier.

For example, the model M1 receives, as the input, tabular data containing a plurality of types of data as illustrated in FIG. 10. For example, the model M1 receives, as the input, combinations of the information obtained by conversion, into a text, of each set of tabular data containing a plurality of types of data as illustrated in FIG. 10.

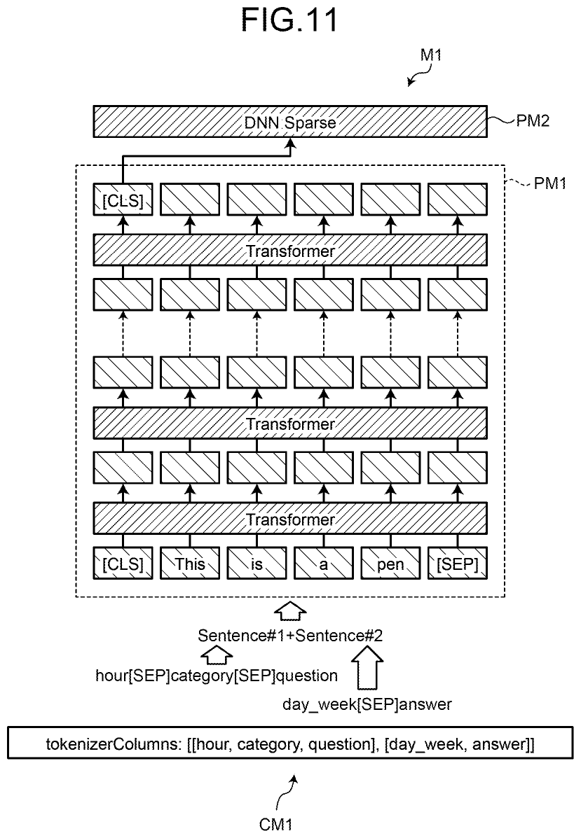

Meanwhile, combinations of a variety of abovementioned information can also be used as the input to the model M1. Regarding that point, an example is explained below. For example, the input to the model M1 can be as illustrated in FIG. 11. FIG. 11 is a diagram illustrating an example of the input given to a model according to the embodiment. Regarding the details identical to the details explained with reference to FIG. 7, the explanation is not given again.

For example, to the model M1 illustrated in FIG. 11, the sentence Sentence #1 is input in the form of a text in which the following information is arranged in the given order: the information obtained by conversion, into a text, of the information indicating the date and time at which a question was posted; the token “SEP”; the information obtained by conversion, into a text, of the information indicating the category of a question; the token “SEP”; and a text corresponding to the question (question sentence). That is, in FIG. 11, as the sentence Sentence #1, a single text is used in which the information obtained by conversion, into a text, of the information indicating the date and time at which a question was posted; the information obtained by conversion, into a text, of the information indicating the category of a question; and the text corresponding to the question are concatenated using the tokens “SEP”.

Moreover, to the model M1 illustrated in FIG. 11, the following is input as the sentence Sentence #2: the information obtained by conversion, into a text, of the information indicating the day of the week on which an answer was posted; the token “SEP”; and a text corresponding to the answer (answer sentence). That is, in FIG. 11, as the sentence Sentence #2, a single text is used in which the information obtained by conversion, into a text, of the information indicating the day of the week on which the answer was posted is concatenated to the text corresponding to the answer using the token “SEP”.

Meanwhile, input information CM1 illustrated in FIG. 11 represents an example of the specification of the input.

For example, when a date and time, a category, and a question are to be specified as the sentence Sentence #1 representing the input to the model M1, a character string is used in which character strings indicating various types are separated by separating characters (commas in the example illustrated in FIG. 11) and are parenthesized in a square bracket. More particularly, a character string “[hour, category, question]” is used as the specification of the sentence Sentence #1.

Moreover, when a day of the week and an answer are to be specified as the sentence Sentence #2 representing the input to the model M1, a character string is used in which character strings indicating various types are separated by separating characters (commas in the example illustrated in FIG. 11) and are parenthesized in a square bracket. More particularly, a character string “[day_week, answer]” is used as the specification of the sentence Sentence #2.

In the example illustrated in FIG. 11, as the overall input to the model M1, a character string is used in which the information of various types such as the sentences Sentence #1 and Sentence #2 is separated by separating characters (commas in the example illustrated in FIG. 11). More particularly, a character string “tokenizerColumns: [[hour, category, question], [day_week, answer]]” is used as the specification of the input to the model M1.

### [7-3. Other Exemplary Structure of Model]

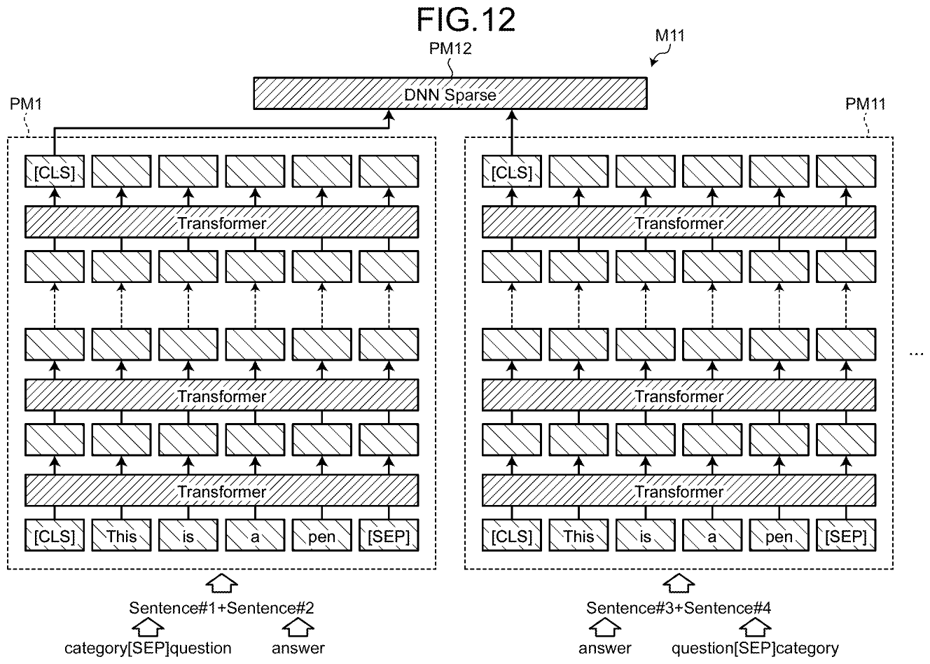

The structure of a model as explained above is only exemplary, and it is possible to have an arbitrary configuration for a model. Regarding that point, the explanation is given below with reference to FIG. 12. FIG. 12 is a diagram illustrating another exemplary structure of a model according to the embodiment. Regarding the constituent elements identical to FIG. 7, the same reference numerals are used and the explanation is not given again.

With reference to FIG. 12, the information processing system 1 generates a model M11 that includes various configurations of a plurality of partial models, such as partial models PM1 and PM11 representing examples of the base model, and a partial model PM12 in which the output of the partial models PM1 and PM11 is used as the input. That is, as compared to the model M1, the model M11 differs in the way of including the partial model P11 and including the partial model PM12 in which the output of the partial models PM11 and PM1 is used as the input.

For example in an identical manner to the partial model PM1, the partial model PM11 is a model (language model) based on transformers. That is, the internal configuration of the partial model PM11 is identical to the internal configuration of the partial model PM1. Hence, that explanation is not given again.

In FIG. 12, the partial model PM2 having “DNN Sparse” written therein represents the partial model PM in which the output of the partial models PM1 and PM11 is used as the input. Meanwhile, apart from the fact that the output of the partial model PM11 is used as the input thereto, the partial model PM12 is identical to the partial model PM2. Hence, its explanation is not given again.

In FIG. 12 is illustrated an example of the input given to the model M11. With reference to FIG. 12, the sentences Sentence #1 and Sentence #2 are input to the partial model PM1, and sentences Sentence #3 and Sentence #4 are input to the partial model PM11. Herein, the sentences Sentence #1 and Sentence #2 that are input to the partial model PM1 are identical to FIG. 7. Hence, their explanation is not given again.

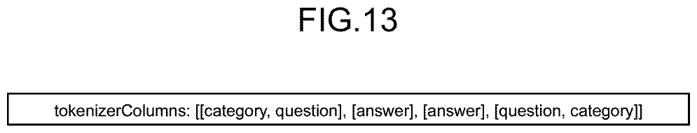

In FIG. 12 is illustrated an example in which the two sentences Sentence #3 and Sentence #4 are input to (the partial model PM11) of the model M11. For example, in FIG. 12, a text corresponding to an answer (answer sentence) is input as the sentence Sentence #3 to the model PM11. Moreover, the sentence Sentence #4 is input in the form of a text in which the following information is arranged in the given order: the information corresponding to a question (question sentence); the token “SEP”; and the information obtained by conversion, into a text, of the information indicating the category of the question. In FIG. 13 is illustrated an example of the specification of the input illustrated in FIG. 12. FIG. 13 is a diagram illustrating an example of the input given to a model according to the embodiment.

For example, when an answer is to be specified as the sentence Sentence #3 representing the input to the model M11, a character string is used in which a character string indicating the type of the answer is parenthesized in a square bracket. More particularly, a character string “[answer]” is used as the specification of the sentence Sentence #3.

Moreover, when a question and a category are to be specified as the sentence Sentence #4 representing the input to the model M11, a character string is used in which character strings indicating various types are separated by separating characters (commas in the example illustrated in FIG. 13) and are parenthesized in a square bracket. More particularly, a character string “[question, category]” is used as the specification of the sentence Sentence #4.

In the example illustrated in FIG. 13, as the overall input to the model M11, a character string is used in which the information of various types such as the sentences Sentence #1, Sentence #2, Sentence #3, and Sentence #4 is separated by separating characters (commas in the example illustrated in FIG. 13). More particularly, a character string “tokenizerColumns: [[category, question], [answer], [answer], [category, question]]” is used as the specification of the input to the model M11. In this way, the model M11 allows repetitive input of texts.

### [7-4. Experimental Results]

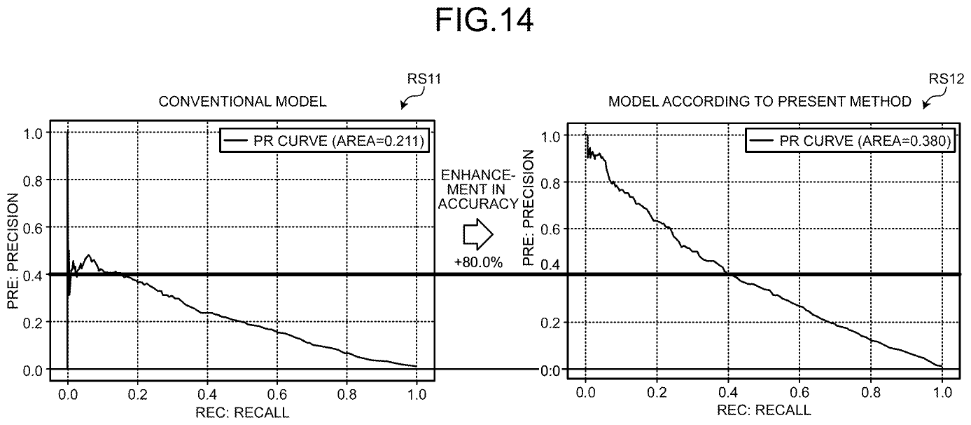

Explained below with reference to FIGS. 14 to 18 are exemplary experimental results of the experiments performed using a model generated according to the operations explained above. FIGS. 14 to 18 are diagrams illustrating exemplary experimental results.

Firstly, the explanation is given about the example illustrated in FIG. 14. This example is about the experimental result obtained in the case of determining the violation posting of an answer in a knowledge sharing service involving posts of questions and answers.

A result RS11 that is illustrated on the left side in FIG. 14 indicates the experimental result obtained in the case of using a conventional model. In the result RS11, the vertical axis represents the precision and the horizontal axis represents the recall. Moreover, in the result RS11, the waveform in the graph represents a PR curve. For example, in the conventional model, BERT is used and an answer representing a sentence is received as the input.

On the other hand, a result RS12 that is illustrated on the right side in FIG. 14 indicates the experimental result obtained in the case of using a model according to the present method. In the result RS12, the vertical axis represents the precision and the horizontal axis represents the recall. Moreover, in the result RS12, the waveform in the graph represents a PR curve. For example, the model according to the present method includes, for example, a base model (the partial model PM1) similar to the model M1 explained earlier and includes a DNN sparse model (the partial model PM2). Moreover, the model according to the present method receives the following as the input: the information obtained by conversion, into a text, of the category; combinations of questions representing sentences; and answers representing sentences.

As illustrated in the results RS11 and RS12 in FIG. 14, in the model according to the present method, it was possible to achieve an enhancement of 80% in the accuracy as compared to the conventional model. In this way, it was demonstrated that, as a result of using a model in which the types of information not receivable as texts in the past can be input as texts, the accuracy regarding violation posting determination of answers can be enhanced.

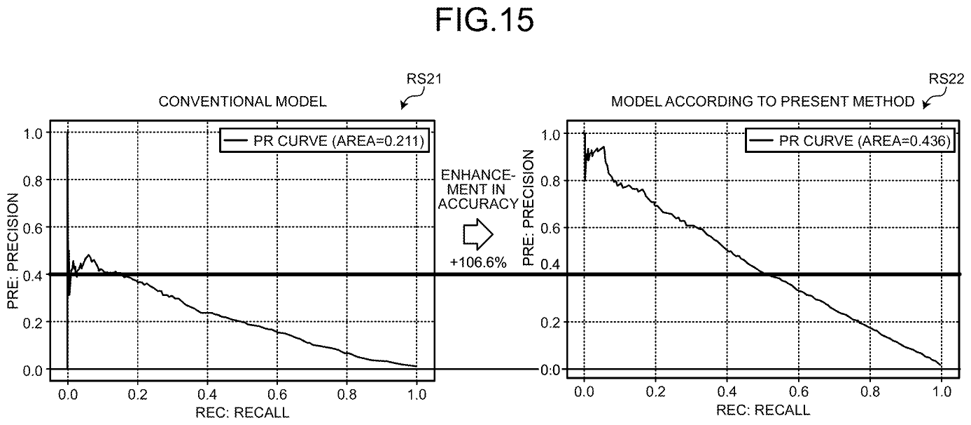

Given below is the explanation about the example illustrated in FIG. 15. This example is about the experimental result obtained in the case of determining the violation posting of an answer in a knowledge sharing service involving posts of questions and answers. Regarding the identical points to FIG. 14, the explanation is not given again.

In an identical manner to the result RS11 illustrated on the left side in FIG. 14, a result RS21 that is illustrated on the left side in FIG. 15 indicates the experimental result obtained in the case of using a conventional model. In the result RS21, the waveform in the graph represents a PR curve. Thus, the result RS21 illustrated on the left side in FIG. 15 is identical to the result RS11 illustrated on the left side in FIG. 14. Hence, the same explanation is not given again.

On the other hand, a result RS22 that is illustrated on the right side in FIG. 15 indicates the experimental result obtained in the case of using a model according to the present method. In the result RS22, the vertical axis represents the precision and the horizontal axis represents the recall. Moreover, in the result RS22, the waveform in the graph represents a PR curve. For example, the model according to the present method is obtained when, for example, a base model (the partial model PM1) is learnt using the data of the knowledge sharing service, so that a base model suitable to the knowledge sharing service is learnt. Moreover, the model according to the present method receives the following as the input: the information obtained by conversion, into a text, of the category; combinations of questions representing sentences; and answers representing sentences.

As illustrated in the results RS21 and RS22 in FIG. 15, in the model according to the present method, it was possible to achieve an enhancement of 106.6% in the accuracy as compared to the conventional model. In this way, it was demonstrated that, as a result of learning a base model, in which the types of information not receivable as texts in the past can be input as texts, using the data of the concerned service; the accuracy regarding violation posting determination of answers can be further enhanced.

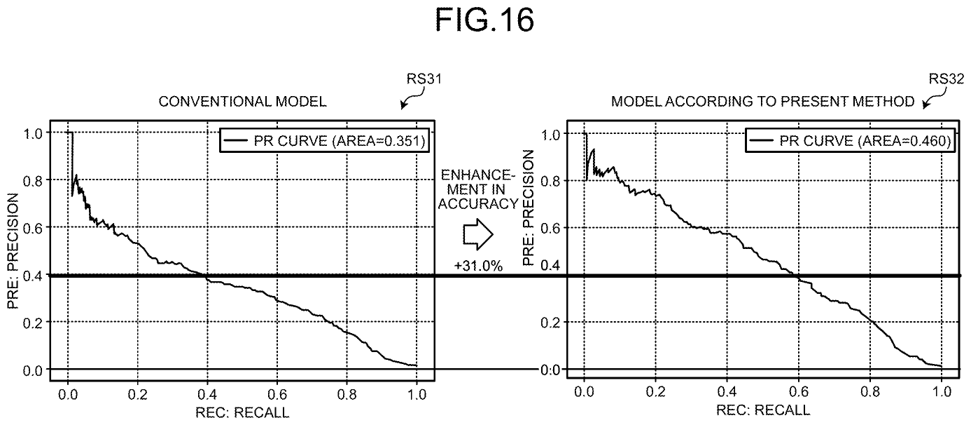

Given below is the explanation about the example illustrated in FIG. 16. This example is about the experimental result obtained in the case of determining the violation posting of a question in a knowledge sharing service involving posts of questions and answers. Regarding the identical points to FIGS. 14 and 15, the explanation is not given again.

A result RS31 that is illustrated on the left side in FIG. 16 indicates the experimental result obtained in the case of using a conventional model. In the result RS31, the vertical axis represents the precision and the horizontal axis represents the recall. Moreover, in the result RS31, the waveform in the graph represents a PR curve. For example, in the conventional model, BERT is used and a question representing a sentence is received as the input.

On the other hand, a result RS32 that is illustrated on the right side in FIG. 16 indicates the experimental result obtained in the case of using a model according to the present method. In the result RS32, the vertical axis represents the precision and the horizontal axis represents the recall. Moreover, in the result RS32, the waveform in the graph represents a PR curve. For example, the model according to the present method includes, for example, a base model (the partial model PM1) similar to the model M1 explained earlier and includes a DNN sparse model (the partial model PM2). Moreover, the model according to the present method receives the following as the input: the information obtained by conversion, into a text, of the category; and a combination of questions representing sentences.

As illustrated in the results RS31 and RS32 in FIG. 16, in the model according to the present method, it was possible to achieve an enhancement of 31% in the accuracy as compared to the conventional model. In this way, it was demonstrated that, as a result of using a model in which the types of information not receivable as texts in the past can be input as texts, the accuracy regarding violation posting determination of questions can be enhanced.

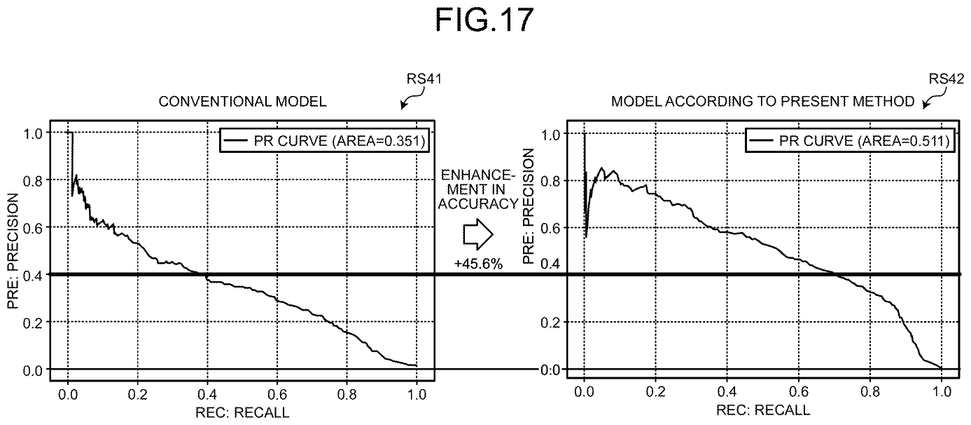

Given below is the explanation about the example illustrated in FIG. 17. This example is about the experimental result obtained in the case of determining the violation posting of a question in a knowledge sharing service involving posts of questions and answers. Regarding the identical points to FIGS. 14 to 16, the explanation is not given again.

In an identical manner to the result RS31 illustrated on the left side in FIG. 16, a result RS41 that is illustrated on the left side in FIG. 17 indicates the experimental result obtained in the case of using a conventional model. In the result RS41, the waveform in the graph represents a PR curve. Thus, the result RS41 illustrated on the left side in FIG. 17 is identical to the result RS31 illustrated on the left side in FIG. 16. Hence, the same explanation is not given again.

On the other hand, a result RS42 that is illustrated on the right side in FIG. 17 indicates the experimental result obtained in the case of using a model according to the present method. In the result RS42, the vertical axis represents the precision and the horizontal axis represents the recall. Moreover, in the result RS42, the waveform in the graph represents a PR curve. For example, the model according to the present method is obtained when, for example, a base model (the partial model PM1) is learnt using the data of the knowledge sharing service, so that a base model suitable to the knowledge sharing service is learnt. Moreover, the model according to the present method receives the following as the input: the information obtained by conversion, into a text, of the category; and a combination of questions representing sentences.

As illustrated in the results RS41 and RS42 in FIG. 17, in the model according to the present method, it was possible to achieve an enhancement of 45.6% in the accuracy as compared to the conventional model. In this way, it was demonstrated that, as a result of learning a base model, in which the types of information not receivable as texts in the past can be input as texts, using the data of the concerned service; the accuracy regarding violation posting determination of questions can be further enhanced.

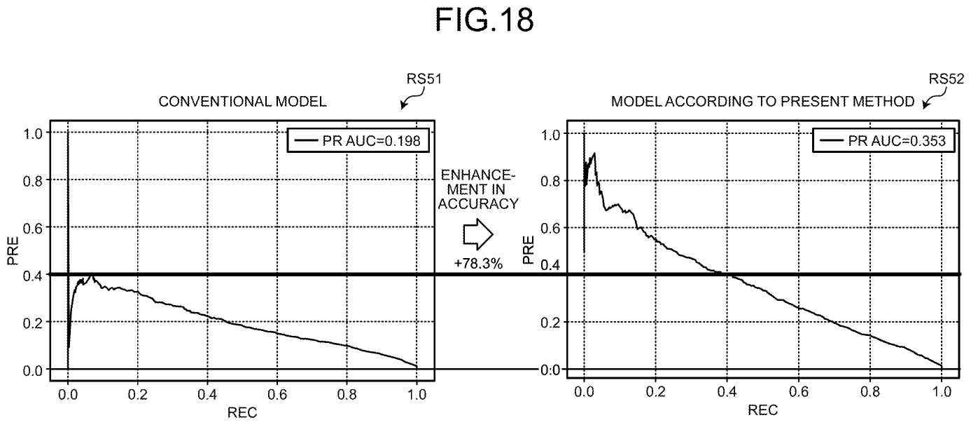

Given below is the explanation about the example illustrated in FIG. 18. This example is about the experimental result obtained in the case of determining the violation posting of a comment in a commenting service for news articles. Regarding the identical points to FIGS. 14 to 17, the explanation is not given again.

A result RS51 that is illustrated on the left side in FIG. 18 indicates the experimental result obtained in the case of using a conventional model. In the result RS51, the vertical axis represents the precision and the horizontal axis represents the recall. Moreover, in the result RS51, the waveform in the graph represents PR AUC. For example, in the conventional model, BERT is used and a comment representing a sentence is received as the input.

On the other hand, a result RS52 that is illustrated on the right side in FIG. 18 indicates the experimental result obtained in the case of using a model according to the present method. In the result RS52, the vertical axis represents the precision and the horizontal axis represents the recall. Moreover, in the result RS52, the waveform in the graph represents PR AUC. For example, the model according to the present method is obtained when, for example, a base model (the partial model PM1) is learnt using the data of the commenting service, so that a base model suitable to the commenting service is learnt. Moreover, the model according to the present method receives the following as the input: the information obtained by conversion, into a text, of the headline of a news article; and a combination of comments representing sentences.

As illustrated in the results RS51 and RS52 in FIG. 18, in the model according to the present method, it was possible to achieve an enhancement of 78.3% in the accuracy as compared to the conventional model. In this way, it was demonstrated that, as a result of learning a base model, in which the types of information not receivable as texts in the past can be input as texts, using the data of the concerned service; the accuracy regarding violation posting determination of comments can be further enhanced.

### 8. Example of Learning Operation

The information processing system 1 can learn various models such as the models M1 and M11 according to various learning methods. For example, the information processing system 1 can learn various partial models PM, such as the partial model PM1 representing the base model of the model M1, according to an arbitrary learning method.

For example, the information processing apparatus 10 can perform a multistage learning operation and generate the partial model PM1 representing the base model of the model M1. For example, the information processing apparatus 10 can perform a multistage learning operation that includes the first-stage learning operation using the first-type data constellation which, from among the learning data, is used in the learning of the general-purpose language capacity, and can generate the partial model PM1 representing the base model of the model M1.

Moreover, the information processing apparatus 10 can perform a multistage learning operation that includes the second-stage learning operation using the second-type data constellation which is used in the learning of the language capacity meant for specific processing, and can generate the partial model PM1 representing the base model of the model M1. For example, the second-type data constellation represents posting data on the Internet that is used in the learning of a model to be used in the operations related to the posts on the Internet.

Still alternatively, the information processing apparatus 10 can perform a multistage learning operation that includes the third-stage learning operation in which the learning is performed by increasing the layers of the base model, and can generate the partial model PM1 representing the base model of the model M1. As the data constellation to be used in the third-stage learning operation, the second-type data constellation can be used. For example, the information processing apparatus 10 can perform the third-stage learning operation in a repeated manner; can perform the operation of increasing the layers of the base model and perform a learning operation with respect to the base model having an increased number of layers; and can generate the partial model PM1 representing the base model of the model M1.

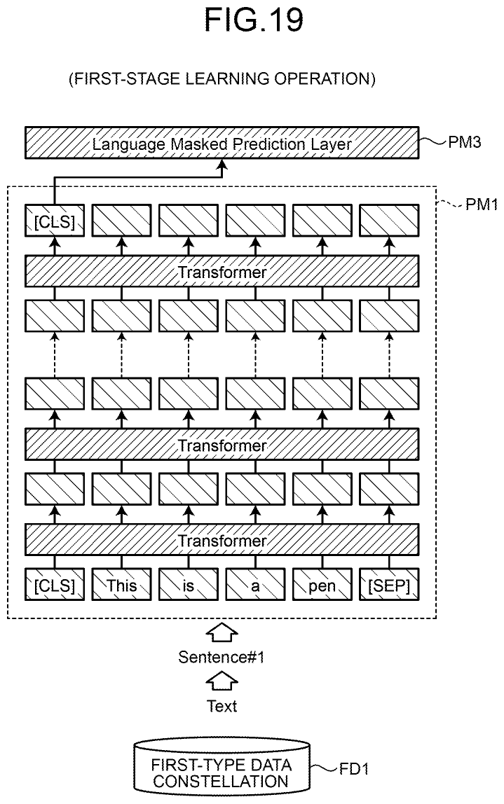

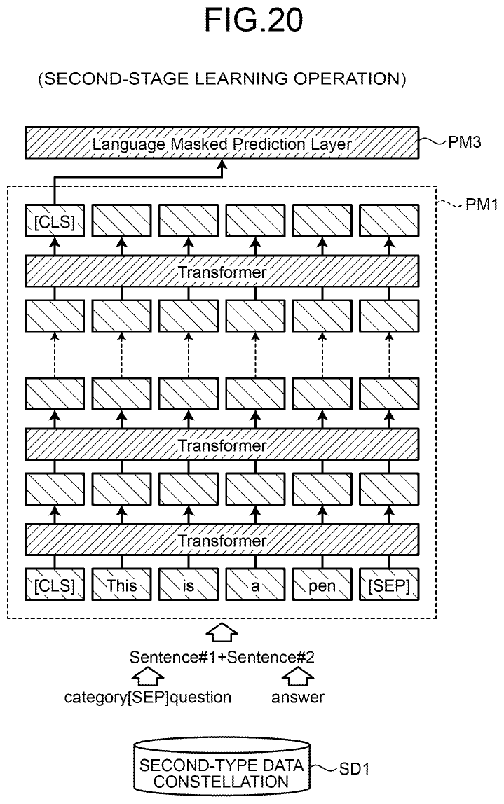

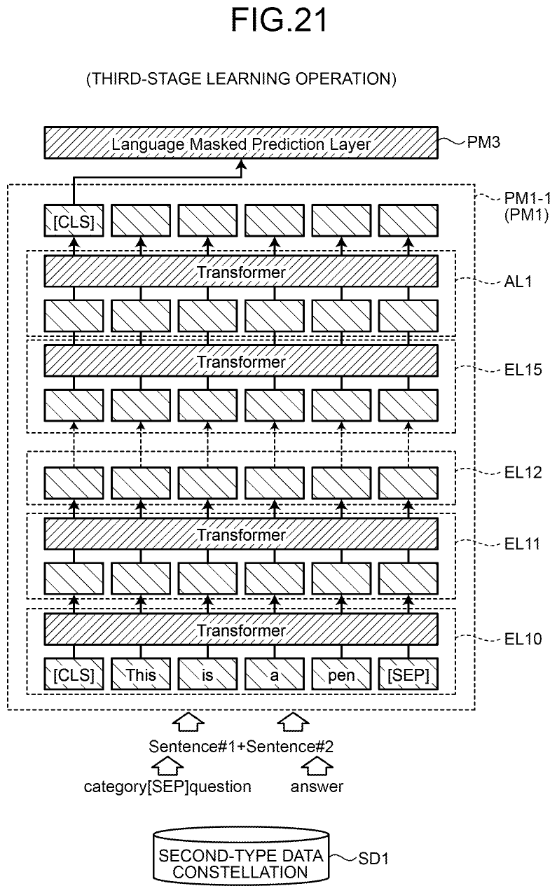

Explained below with reference to FIGS. 19 to 21 is an example of the generation operation for generating the partial model PM1 representing the base model of the model M1. FIGS. 19 to 21 are diagrams for explaining an example of a generation operation for generating a model according to the embodiment. For example, FIG. 19 is a diagram for explaining an example of the first-stage learning operation with respect to the partial model PM1. FIG. 20 is a diagram for explaining an example of the second-stage learning operation with respect to the partial model PM1. FIG. 21 is a diagram for explaining an example of the third-stage learning operation with respect to the partial model PM1. Regarding the details that are already explained, the same explanation is not given again.

Firstly, the information processing apparatus 10 performs the first-stage learning operation as illustrated in FIG. 19 and learns the partial model PM1 representing the base model of the model M1. The first-stage learning operation illustrated in FIG. 19 is performed in the state in which the output of the partial model PM1 is given as the input to a partial model PM3 having “Language Masked Prediction Layer” written therein. For example, the partial model PM3 predicts the masked character strings in an input sentence (text). In this way, in the case of learning the partial model PM1 representing the base model, the information processing apparatus 10 can perform the learning by replacing, from the post-learning model to be used in a service (for example, the model M1), a partial model (for example, the partial model PM2) with a partial model having a different function (for example, the partial model PM3).

For example, in the first-stage learning operation illustrated in FIG. 19, natural language data used in the learning of a large-scale language model is used as a first-type data constellation FD1. In the first-type data constellation FD1, an arbitrary dataset such as Wikipedia, CC-100, or OSCAR Data can be used. For example, the information processing apparatus 10 uses the sentences included in the first-type data constellation FD1 (also called “first-type sentences”) and performs the first-stage learning operation. For example, the information processing apparatus 10 treats, as the input, a document obtained by masking some portions of the first-type sentences included in the first-type data constellation FD1; performs learning in such a way that the character strings in the masked portions of the first-type sentences are accurately predicted by the partial model PM3; and thus learns the partial model PM1. As a result, the information processing apparatus 10 becomes able to learn (generate) the partial model PM1 equipped with the general-purpose language capacity.

Then, the information processing apparatus 10 performs the second-stage learning operation as illustrated in FIG. 20 and learns the partial model PM1 representing the base model of the model M1. Meanwhile, regarding FIG. 20, the identical points to FIG. 19 are not explained again. For example, the information processing apparatus 10 uses the partial model PM1 that was learnt in the first-stage learning operation as illustrated in FIG. 19, and further learns the partial model PM1 according to the second-stage learning operation as illustrated in FIG. 20.

In FIG. 20, in an identical model configuration to the first-stage learning operation, the information processing apparatus 10 performs additional learning using a second-type data constellation SD1 and further learns the partial model PM1. For example, the information processing apparatus 10 performs the second-stage learning operation using data for fine-tuning as the second-data constellation SD1, and learns the partial model PM1. For example, the information processing apparatus 10 performs the second-stage learning operation in which the second-type data constellation SD1 is used for fine-tuning the model used in violation posting determination (for example, the model M1), and learns the partial model PM1.

In FIG. 20 is illustrated an example in which the two sentences Sentence #1 and Sentence #2 are input to the partial model PM1. For example, to the partial model PM1 illustrated in FIG. 20, the sentence Sentence #1 is input in the form of a text in which the following information is arranged in the given order: the information obtained by conversion, into a text, of the information indicating the category of a question; the token “SEP”; and the text corresponding to the concerned question (question sentence). That is, in FIG. 20, as the sentence Sentence #1, a single text is used in which the information obtained by conversion, into a text, of the category of a question is concatenated to the text corresponding to the question using the token “SEP”.

In the partial model PM1 illustrated in FIG. 20, the sentence Sentence #2 is input in the form of a text corresponding to the answer (answer sentence). That is, in FIG. 20, a text corresponding to the answer is used in the sentence Sentence #2.

In this way, the information processing apparatus 10 performs the second-stage learning operation using the second-type data constellation SD1 that represents the data for fine-tuning as meant for learning a model for the inference operation related to the posting of questions and answers. For example, the information processing apparatus 10 performs the second-stage learning operation using the sentences included in the second-type data constellation SD1 (also called “second-type sentences”). For example, the information processing apparatus 10 treats, as the input, a document obtained by masking some portions of the second-type sentences included in the second-type data constellation SD1; performs learning in such a way that the character strings in the masked portions of the second-type sentences are accurately predicted by the partial model PM3; and thus learns the partial model PM1. As a result, the information processing apparatus 10 becomes able to learn (generate) the partial model PM1 equipped with the language capacity meant for specific processing.

Subsequently, the information processing apparatus 10 performs the third-stage learning operation as illustrated in FIG. 21 and learns the partial model PM1 representing the base model of the model M1. With reference to FIG. 21, the identical points to FIGS. 19 and 20 are not explained again. For example, the information processing apparatus 10 uses the partial model PM1 that has been learnt according to the second-stage learning operation as illustrated in FIG. 20, and further learns the partial model PM1 according to the third-stage learning operation as illustrated in FIG. 21.

With reference to FIG. 21, the information processing apparatus 10 performs the third-stage learning operation in which learning is performed by adding layers to the partial model PM1 that was learnt according to the first-stage learning operation and the second-stage learning operation, and thus further learns the partial model PM1. In FIG. 21, as illustrated in a partial model PM1-1, the information processing apparatus 10 performs the third-stage learning operation in which learning is performed by adding a layer AL1 representing an additional layer, and thus further learns the partial model PM1. For example, the information processing apparatus 10 performs the third-stage learning operation in which the data for fine-tuning is used as the second-type data constellation SD1, and learns the partial model PM1 by adding layers to the partial model PM1.

For example, in the third-stage learning operation, the information processing apparatus 10 can increase the data by adding new records and making duplicate copies. Moreover, in the third-stage learning operation, the information processing apparatus 10 can optimize the learning rate and set the scheduler to “constant”. For example, the information processing apparatus 10 can set the batch size to an arbitrary value (for example, 34, 560) and perform the third-stage learning operation. For example, by setting the batch size to be equal to or greater than 6,900, the information processing apparatus 10 becomes able to stabilize the learning and perform optimization for shortening the learning time. Moreover, for example, the MLM (Masked Language Model) probability represents the optimization target, and can be set in the range from 0.15 to 0.45.

Meanwhile, the state in which a single layer AL1 is added as illustrated in FIG. 21 is only an exemplary configuration of the partial model PM1. That is, two or more layers can also be added to the partial model PM1. For example, the information processing apparatus 10 can perform the third-stage learning operation in a repeated manner; add layers to the base model and perform a learning operation with respect to the base model having an increased number of layers; further add layers to the partial model PM1; and generate the partial model PM1.

### [8-1. Experimental Results]

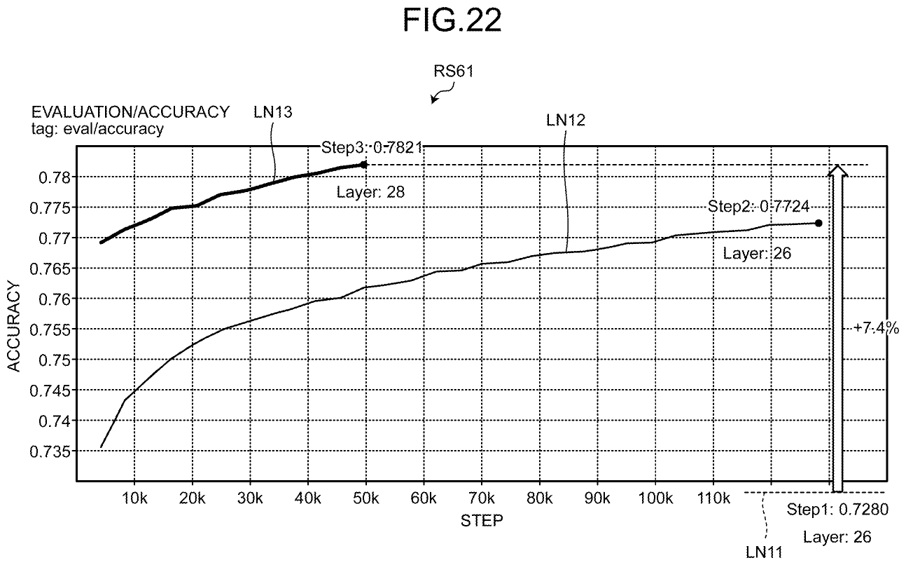

Explained below with reference to FIGS. 22 to 25 are exemplary experimental results of the experiments performed using a model generated according to the multistage learning operation explained above. FIGS. 22 to 25 are diagrams illustrating exemplary experimental results.

Firstly, the explanation is given about the example illustrated in FIG. 22. In FIG. 22 is illustrated an example of the experimental result regarding the base model (for example, the partial model PM1) used in a knowledge sharing service involving posts of questions and answers. In a result RS61 illustrated in FIG. 22, the horizontal axis represents the number of steps involved in the learning operation, and the vertical axis represents the accuracy of the MLM task performed using the base model.

In FIG. 22, a line LN11 indicates the accuracy of the MLM task performed using the base model in the first-stage learning operation (in FIG. 22, Step1). In FIG. 22, it is illustrated that there are 26 layers of the base model learnt in the first-stage learning operation and that the MLM task performed using the base model has the accuracy of “0.7280”.

In FIG. 22, a line LN12 indicates the accuracy of the MLM task performed using the base model in the second-stage learning operation (in FIG. 22, Step2). In FIG. 22, it is illustrated that there are 26 layers of the base model learnt in the second-stage learning operation and that the MLM task performed using the base model has an increased accuracy of “0.7724”.

In FIG. 22, a line LN13 indicates the accuracy of the MLM task performed using the base model in the third-stage learning operation (in FIG. 22, Step3). In FIG. 22, it is illustrated that there are 28 layers of the base model learnt in the third-stage learning operation and that the MLM task performed using the base model has an increased accuracy of “0.7821”.

In this way, in the result RS61 illustrated in FIG. 22, as indicated by the lines LN11 to LN13, regarding the base model in the case in which optimization is done for a knowledge sharing service, as a result of performing the second-stage learning operation and the third-stage learning operation, it was possible to achieve an enhancement of 7.4% in the accuracy. In this way, it was demonstrated that the information processing apparatus 10 enables achieving enhancement in the accuracy based on a multistage learning operation.

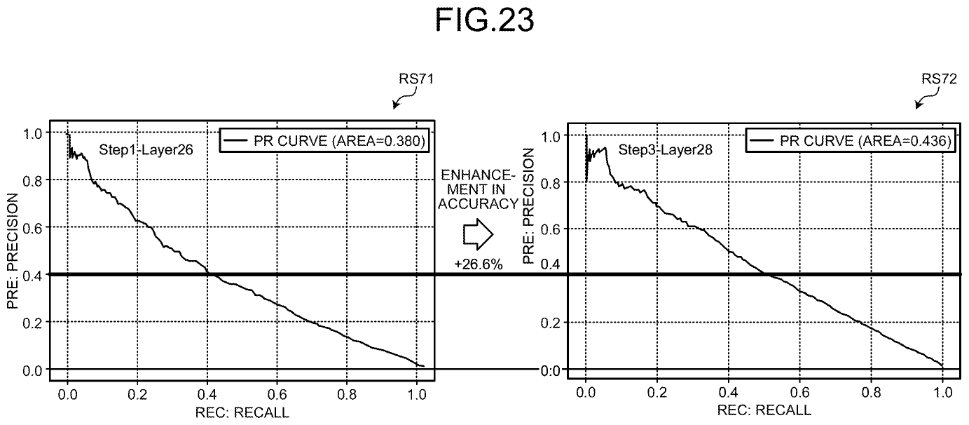

Given below is the explanation of the example illustrated in FIG. 23. In FIG. 23 is illustrated an example of the experimental result obtained in the case of determining violation posting of an answer in a knowledge sharing service involving posts of questions and answers. Regarding the details that are already explained, the same explanation is not given again.

A result RS71 that is illustrated on the left side in FIG. 23 indicates the experimental result obtained in the case of using a conventional model. In the result RS71, the vertical axis represents the precision and the horizontal axis represents the recall. Moreover, in the result RS71, the waveform in the graph represents a PR curve. For example, in the conventional model, DeBERTa is used and an answer representing a sentence is received as the input. The result RS71 represents the experimental result obtained in the case of using a model that is subjected to a learning operation corresponding to the first-stage learning operation and that has 26 layers.

On the other hand, a result RS72 that is illustrated on the right side in FIG. 23 indicates the experimental result obtained in the case of using a model according to the present method. In the result RS72, the vertical axis represents the precision and the horizontal axis represents the recall. Moreover, in the result RS72, the waveform in the graph represents a PR curve. For example, the model according to the present method is a model in the case in which the data of a knowledge sharing service is used, the second-stage learning operation and the third-stage learning operation are performed with respect to the base model (the partial model PM1) that has been learnt according to the multistage learning operation explained earlier, and the base model is optimized to the knowledge sharing system; and is a model that receives an answer representing a sentence as the input. The result RS72 represents the experimental result obtained in the case of using a model that has been subjected to a learning operation including all of the first-stage learning operation to the third-stage learning operation and that has 28 layers.

As illustrated in the results RS71 and RS72 in FIG. 23, in the model according to the present method, it was possible to achieve an enhancement of 26.6% in the accuracy as compared to the conventional model. In this way, it was demonstrated that, as a result of performing learning according to the multistage learning operation, the accuracy regarding violation posting determination of answers can be further enhanced.

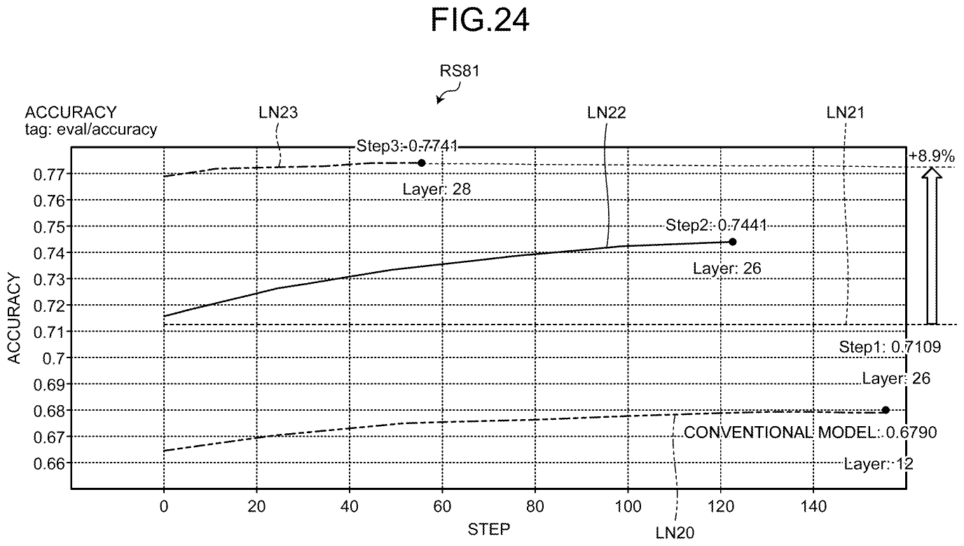

Given below is the explanation of the example illustrated in FIG. 24. In FIG. 24 is illustrated an example of the experimental result regarding the base model (for example, the partial model PM1) used in a commenting service for news articles. Regarding the details identical to the details explained earlier, the explanation is not given again. In a result RS81 illustrated in FIG. 24, the horizontal axis represents the number of steps involved in the learning operation, and the vertical axis represents the accuracy of the MLM task performed using the base model.

In FIG. 24, a line LN20 indicates the accuracy of the MLM task performed using a conventional model. In FIG. 24, it is illustrated that the conventional model is a base model learnt based on DeBERTa and having 12 layers, and that the MLM task performed using the base model has the accuracy of “0.6790”.

In FIG. 24, a line LN21 indicates the accuracy of the MLM task performed using the base model in the first-stage learning operation (in FIG. 24, Step1). In FIG. 24, it is illustrated that there are 26 layers of the base model learnt in the first-stage learning operation and that the MLM task performed using the base model has the accuracy of “0.7109”.

In FIG. 24, a line LN22 indicates the accuracy of the MLM task performed using the base model in the second-stage learning operation (in FIG. 24, Step2). In FIG. 24, it is illustrated that there are 26 layers of the base model learnt in the second-stage learning operation and that the MLM task performed using the base model has an increased accuracy of “0.7441”.

In FIG. 24, a line LN23 indicates the accuracy of the MLM task performed using the base model in the third-stage learning operation (in FIG. 24, Step3). In FIG. 24, it is illustrated that there are 28 layers of the base model learnt in the third-stage learning operation and that the MLM task performed using the base model has an increased accuracy of “0.7741”.

In this way, in the result RS81 illustrated in FIG. 24, as indicated by the lines LN21 to LN23, regarding the base model in the case in which optimization is done for a commenting service for news articles, as a result of performing the second-stage learning operation and the third-stage learning operation, it was possible to achieve an enhancement of 8.9% in the accuracy. In this way, it was demonstrated that the information processing apparatus 10 enables achieving enhancement in the accuracy based on a multistage learning operation.

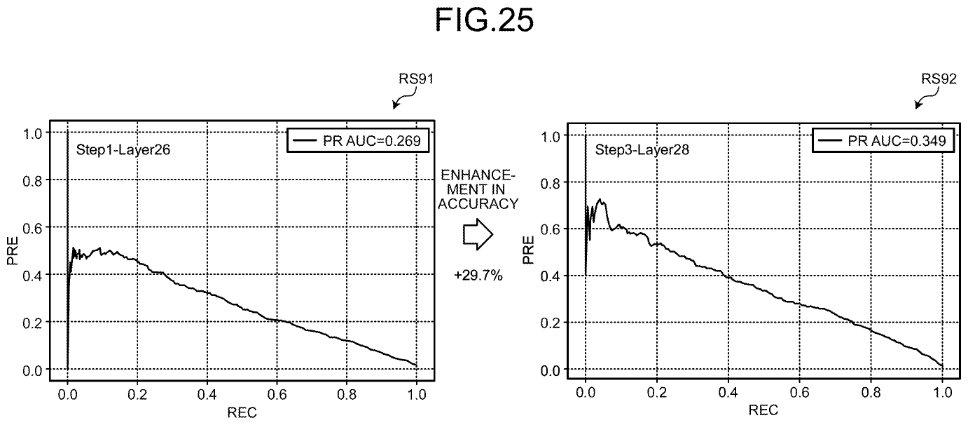

Given below is the explanation of the example illustrated in FIG. 25. In FIG. 25 is illustrated an example of the experimental result obtained in the case of determining violation posting of a comment in a commenting service for news articles. Regarding the details identical to the details explained earlier, the explanation is not given again.

A result RS91 that is illustrated on the left side in FIG. 25 indicates the experimental result obtained in the case of using a conventional model. In the result RS91, the vertical axis represents the precision and the horizontal axis represents the recall. Moreover, in the result RS91, the waveform in the graph represents PR AUC. For example, in the conventional model, DeBERTa is used and a comment representing a sentence is received as the input. The result RS91 represents the experimental result obtained in the case of using a model that is subjected to a learning operation corresponding to the first-stage learning operation and that has 26 layers.

On the other hand, a result RS92 that is illustrated on the right side in FIG. 25 indicates the experimental result obtained in the case of using a model according to the present method. In the result RS92, the vertical axis represents the precision and the horizontal axis represents the recall. Moreover, in the result RS92, the waveform in the graph represents PR AUC. For example, the model according to the present method is a model in the case in which the data of a commenting service for news articles is used, the second-stage learning operation and the third-stage learning operation are performed with respect to the base model (the partial model PM1) that has been learnt according to the multistage learning operation explained earlier, and the base model is optimized to the commenting service for news articles; and is a model that receives a comment representing a sentence as the input. The result RS92 represents the experimental result obtained in the case of using a model that has been subjected to a learning operation including all of the first-stage learning operation to the third-stage learning operation and that has 28 layers.

As illustrated in the results RS91 and RS92 in FIG. 25, in the model according to the present method, it was possible to achieve an enhancement of 29.7% in the accuracy as compared to the conventional model. In this way, it was demonstrated that, as a result of performing learning according to the multistage learning operation, the accuracy regarding violation posting determination of comments on news articles can be further enhanced.

### [8-2. Other Example of Operations]

Given below is the explanation of another example of the operations, under the premise of the details given above. For example, in the example explained above, a text obtained by conversion of information other than sentence texts representing sentences is treated as an example of the post-conversion information. However, the input to a model is not limited to a text.

For example, the information processing system 1 can perform learning using the information other than sentences and generate a base model and a model obtained by fine-tuning the base model to be applicable to a particular task (also called a “fine-tuned model”). For example, the information processing system 1 performs learning using the information other than sentences, and learns the partial model PM1 representing the base model. For example, the information processing system 1 performs learning using the information other than sentences, and learns a fine-tuned model (for example, the model M1) that includes the base model (for example, the partial model PM1) and that is fine-tuned to be applicable to a particular task. For example, the information processing system 1 uses the data for fine-tuning and learns the fine-tuned model.

As a result, the information processing system 1 enables achieving enhancement in the accuracy of the base model as well as the fine-tuned model. Moreover, with respect to tabular data other than text data, the information processing system 1 not only can apply BERT models related to BERT explained earlier, but can also apply various types of language models such as GPT models related to GPT (Generative Pretrained Transformer).

For example, the information processing system 1 can generate a base model and a fine-tuned model that has a different input of the input information than the base model. For example, the information processing system 1 treats the input to the fine-tuned model (for example, the model M1), which includes the base model (for example, the partial model PM1), to be different than the input to the base model (for example, the partial model PM1); and learns the fine-tuned model (for example, the model M1).

As a result, in the information processing system 1, the order of input of sentences and information other than sentences to the base model as well as the fine-tuned model can be freely set, including repetition and deletion of the input. As a result, in the information processing system 1, auto-optimization of the order of input can be achieved, and the accuracy of the base model and the fine-tuned model can be enhanced.

For example, the information processing system 1 can generate a base model and a fine-tuned model that has the same order of input of the input information as the base model. For example, the information processing system 1 learns the fine-tuned model (for example, the model M1), which includes the base model (for example, the partial model PM1), with the same order of input as the base model (for example, the partial model PM1).

As a result, the information processing system 1 becomes able to keep the same order of input for sentences and the information other than sentences with respect to the base model and the fine-tuned model. With that, the information processing system 1 becomes able to make use of the features related to the positions of the input information (token positions) as learnt by the base model, and enables achieving enhancement in the accuracy of the fine-tuned model.

Meanwhile, for example, the information processing system 1 can convert the information other than sentences, such as integers, real numbers, and character strings, into information other than texts. For example, the information processing system 1 can perform conversion into an arbitrary format such as “identity”, “vocabulary”, “numeric”, “bucketize”, “identity+embedding”, “vocabulary+embedding”, or “bucketize+embedding”. For example, in the information processing system 1, when information other than sentences such as integers, real numbers, or character strings is to be input, it is believed that the accuracy of the model changes when the information other than sentences such as integers, real numbers, or character strings is input without modification and when the information other than sentences such as integers, real numbers, or character strings is input upon conversion.

In that regard, the information processing apparatus 10 converts (decides on) the format of the information other than sentences, such as integers, real numbers, or character strings to be input to the model as explained earlier. For example, regarding the information other than sentences, such as integers, real numbers, or character strings to be input to the model, the information processing apparatus 10 decides on the format from among the unchanged format, the text format, and some other format. For example, when integers or real numbers are to be input, the information processing system 1 decides whether to input them as numerical values without modification, or to convert them into a text and input the text, or to convert them into some other format such as character strings and input the character strings. Moreover, for example, when character strings are to be input, the information processing system 1 decides whether to input the character strings without modification, or to convert them into a text and input the text, or to convert them into some other format such as numerical values and input the numerical values. For example, the information processing system 1 decides on using the input format that was adapted in the case of generating the model having the highest accuracy.

As a result of performing the operations explained above, the information processing apparatus 10 becomes able to optimize the format of the information (features) to be input. As a result, the information processing system 1 becomes able to perform auto-optimization of arbitrary formats and their combinations according to a feature optimization algorithm. With that, the information processing system 1 enables achieving enhancement in the accuracy of the fine-tuned model.

For example, the information processing system 1 can use label information as the input information at the time of learning of the base model. As a result, during pre-learning of the base model, the information processing system can input the label information too as the input information (input circumstances). Moreover, at the time of pre-learning, the label information can be treated as the masking target; and, at the time of pre-learning of the base model, the information processing system 1 becomes able to ensure the learning in such a way that the label information too can be predicted. As a result, the information processing system 1 enables achieving enhancement in the accuracy of the fine-tuned model.

### 9. Modification Example

The above explanation is given about an example of information processing. However, the embodiment is not limited to that case. Given below is the explanation of a modification example of the information processing.

### [9-1. Device Configuration]

In the embodiment described above, the explanation is given about the example in which the information processing system 1 includes: the information processing apparatus 10 that generates generation indexes, and the model generation server 2 that generates a model according to the generation indexes. However, the embodiment is not limited to that example. Alternatively, the information processing apparatus 10 can be equipped with the functions of the model generation server 2. In that case, it is the terminal device 3 that automatedly generates generation indexes, and carried out automated generation of a model using the model generation server 2.

### [9-2. Miscellaneous]

Of the processes described in the embodiments, all or part of the processes explained as being performed automatically can be performed manually. Similarly, all or part of the processes explained as being performed manually can be performed automatically by a known method. The processing procedures, the control procedures, specific names, various data, and information including parameters described in the embodiments or illustrated in the drawings can be changed as required unless otherwise specified. For example, the variety of information illustrated in the drawings is not limited to the illustrated information.

The constituent elements of the device illustrated in the drawings are merely conceptual, and need not be physically configured as illustrated. The constituent elements, as a whole or in part, can be separated or integrated either functionally or physically based on various types of loads or use conditions.

Meanwhile, embodiments can be appropriately combined without causing any contradiction.

### [9-3. Program]

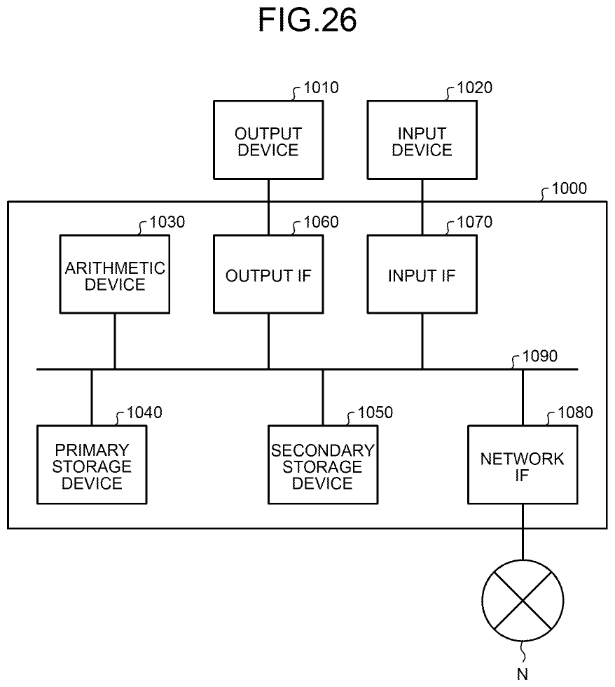

The information processing apparatus 10 according to the embodiment described above is implemented using a computer 1000 having a configuration illustrated in FIG. 26, for example. FIG. 26 is a diagram illustrating an exemplary hardware configuration. The computer 1000 is connected to an output device 1010 and an input device 1020; and includes an arithmetic device 1030, a primary storage device 1040, a secondary storage device 1050, an output IF (Interface) 1060, an input IF 1070, and a network IF 1080 that are connected to each other by a bus 1090.

The arithmetic device 1030 operates based on a program stored in the primary storage device 1040 or the secondary storage device 1050 or operates based on a program read from the input device 1020; and performs various operations. The primary storage device 1040 is a memory device such as a RAM that is used to temporarily store the data to be used in a variety of arithmetic operations by the arithmetic device 1030. The secondary storage device 1050 is a storage device used to store data, which is to be used in a variety of arithmetic operations by the arithmetic device 1030, and to register various databases; and is implemented using a ROM (Read Only Memory), an HDD, or a flash memory.

The output IF 1060 is an interface for sending the information that is to be output to the output device 1010, which is a monitor or a printer used for outputting a variety of information. For example, the output IF 1060 is implemented using a connector having a standard such as USB (Universal Serial Bus), DVI (Digital Visual Interface), or HDMI (registered trademark) (High Definition Multimedia Interface). The input IF 1070 is an interface for receiving information from various input devices 1020 such as a mouse, a keyboard, and a scanner; and is implemented using, for example, a USB.

Alternatively, the input device 1020 can be a device that reads information from, for example, an optical recording medium such as a CD (Compact Disc), a DVD (Digital Versatile Disc), or a PD (Phase change rewritable Disk); or a magneto-optical recording medium such as an MO (Magneto-Optical disk); or a tape medium; or a magnetic recording medium; or a semiconductor memory. Still alternatively, the input device 1020 can be an external memory medium such as a USB memory.

The network IF 1080 receives data from other devices via the network N and sends the data to the arithmetic device 1030, as well as sends the data generated by the arithmetic device 1030 to other devices via the network N.

The arithmetic device 1030 controls the output device 1010 and the input device 1020 via the output IF 1060 and the input IF 1070, respectively. For example, the arithmetic device 1030 loads a program from the input device 1020 or the secondary storage device 1050 into the primary storage device 1040, and executes the loaded program.

For example, when the computer 1000 functions as the information processing apparatus 10, the arithmetic device 1030 of the computer 1000 executes the program loaded in the primary storage device 1040 and implements the functions of the control unit 40.

### 10. Effects

As explained above, the information processing apparatus 10 includes an obtaining unit (in the embodiment, the obtaining unit 41) that obtains the learning data to be used in the learning of a base model (for example, in the embodiment, the partial model PM1) which treats a text as the input; and a generating unit (in the embodiment, the generating unit 44) that performs a multistage learning operation using the learning data and generates a base model. As a result, the information processing apparatus 10 becomes able to generate a base model in an appropriate manner.

Moreover, the obtaining unit obtains the learning data that contains the first-type data constellation to be used in the learning of the general-purpose language capacity. The generating unit performs a multistage learning operation including the first-stage learning operation that makes use of the first-type data constellation, and generates a base model. As a result, the information processing apparatus 10 becomes able to generate a model according to a multistage learning operation that includes the first-stage learning operation performed to learn about the general-purpose language capacity. Thus, the base model can be generated in an appropriate manner.

Furthermore, the obtaining unit obtains the first-type data constellation containing natural language data to be used in the learning of a large-scale language model. As a result, the information processing apparatus 10 becomes able to perform a multistage learning operation including the first-stage learning operation that makes use of natural language data which is used in the learning of a large-scale language model, and to generate a model equipped with the general-purpose language capacity. Thus, the base model can be generated in an appropriate manner.

Moreover, the obtaining unit obtains the learning data that contains the second-type data constellation to be used in the learning of the language capacity meant for specific processing. The generating unit performs a multistage learning operation including the second-stage learning operation that makes use of the second-type data constellation, and generates a base model. As a result, the information processing apparatus 10 becomes able perform a multistage learning operation including the second-stage learning operation that is intended to learn about the language capacity meant for specific processing, and to generate a model. Thus, the base model can be generated in an appropriate manner.

Furthermore, the obtaining unit obtains the learning data containing the second-type data constellation that represents data related to the postings on the Internet. As a result, the information processing apparatus 10 becomes able to perform a multistage learning operation including the second-stage learning operation that makes use of the data related to the postings on the Internet, and to generate a model suitable for specific processing. Thus, the base model can be generated in an appropriate manner.

Moreover, the obtaining unit obtains the second-type data constellation that contains texts corresponding to sentences posted on the Internet. As a result, the information processing apparatus 10 becomes able to perform a multistage learning operation including the second-stage learning operation that makes use of the texts corresponding to sentences posted on the Internet, and to generate a model suitable for processing the posted sentences. Thus, the base model can be generated in an appropriate manner.

Furthermore, the obtaining unit obtains the second-type data constellation that contains texts corresponding to questions posted on the Internet. As a result, the information processing apparatus 10 becomes able to perform a multistage learning operation including the second-stage learning operation that makes use of the texts corresponding to questions posted on the Internet, and to generate a model suitable for processing the posted questions. Thus, the base model can be generated in an appropriate manner.

Moreover, the obtaining unit obtains the second-type data constellation that contains texts corresponding to answers posted on the Internet. As a result, the information processing apparatus 10 becomes able to perform a multistage learning operation including the second-stage learning operation that makes use of the texts corresponding to answers posted on the Internet, and to generate a model suitable for processing the posted answers. Thus, the base model can be generated in an appropriate manner.

The generating unit performs a multistage learning operation including the third-stage learning operation in which learning is performed by increasing the number of layers of the base model, and generates a base model. As a result, the information processing apparatus 10 becomes able to perform a multistage learning operation including the third-stage learning operation in which learning is performed by increasing the number of layers of the base model, and to generate a model. Thus, the base model can be generated in an appropriate manner.

Moreover, the generating unit performs the third-stage learning operation that makes use of the data used in the learning of the language capacity meant for specific processing, and generates a base model. As a result, the information processing apparatus 10 becomes able to perform a multistage learning operation including the third-stage learning operation that makes use of the data used in the learning of the language capacity meant for specific processing, and to generate a model suitable for specific processing. Thus, the base model can be generated in an appropriate manner.

Furthermore, the generating unit performs the third-stage learning operation that makes use of the data related to the postings on the Internet, and generates a base model. As a result, the information processing apparatus 10 becomes able to perform a multistage learning operation including the third-stage learning operation that makes use of the data related to the postings on the Internet, and to generate a model suitable for processing the posted sentences. Thus, the base model can be generated in an appropriate manner.

Moreover, the generating unit performs the third-stage learning operation that makes use of the texts corresponding to the sentences posted on the Internet, and generates a base model. As a result, the information processing apparatus 10 becomes able to perform a multistage learning operation including the third-stage learning operation that makes use of the texts corresponding to the sentences posted on the Internet, and to generate a model suitable for processing the posted sentences. Thus, the base model can be generated in an appropriate manner.

Furthermore, the generating unit performs the third-stage learning operation in a repeated manner; performs the operation of increasing the layers of the base model and performs a learning operation with respect to the base model having an increased number of layers; and generates a base model. As a result, the information processing apparatus 10 becomes able to perform the operation of increasing the layers of the base model and to perform a learning operation with respect to the base model having an increased number of layers. Thus, the base model can be generated in an appropriate manner.

Moreover, the generating unit performs learning using information other than sentences, and generates a base model and generates a fine-tuned model by fine-tuning the base model to be applicable to a predetermined task. As a result, the information processing apparatus 10 becomes able to learn about the base model as well as the fine-tuned model in an appropriate manner. Thus, it becomes possible to generate a model to which information other than sentences can be input in an appropriate manner.

Furthermore, the generating unit generates a base model and generates a fine-tuned model that has a different input of the input information than the base model. As a result, the information processing apparatus 10 becomes able to learn about the base model as well as learn about the fine-tuned model, which has a different input of the input information than the base model, in an appropriate manner. Thus, it becomes possible to generate a model to which information other than sentences can be input in an appropriate manner.

Moreover, the generating unit generates a base model and generates a fine-tuned model that has the same order of input of the input information as the base model. As a result, the information processing apparatus 10 becomes able to learn about the base model as well as learn about the fine-tuned model, which has the same order of input of the input information as the base model, in an appropriate manner. Thus, it becomes possible to generate a model to which information other than sentences can be input in an appropriate manner.

Furthermore, the generating unit generates the base model that treats, as the input, a plurality of sets of input information containing post-conversion information obtained by conversion of the information other than sentence texts representing texts; and generates the fine-tuned model. As a result, the information processing apparatus 10 becomes able to learn about the base model, to which information other than sentences too can be input in the form of a text, as well as learn about the fine-tuned model in an appropriate manner. Thus, it becomes possible to generate a model to which information other than sentences can be input in an appropriate manner.

Meanwhile, the generating unit uses label information as the input information. As a result, the information processing apparatus 10 becomes able to appropriately perform learning using the label information in the base model. Thus, it becomes possible to generate a model to which information other than sentences can be input in an appropriate manner.

Herein, although the description is given about the embodiment of the application concerned, the technical scope of the present invention is not limited to the embodiment described above, and can be construed as embodying various deletions, alternative constructions, and modifications that may occur to one skilled in the art that fairly fall within the basic teaching herein set forth.

Moreover, the terms “section”, “module”, and “unit” mentioned above can be read as “device” or “circuit”. For example, an obtaining unit can be read as an obtaining device or an obtaining circuit.

### EXPLANATIONS OF LETTERS OR NUMERALS

1 information processing system
2 model generation server
3 terminal device
10 information processing apparatus
20 communication unit
30 memory unit
40 control unit
41 obtaining unit
42 deciding unit
43 receiving unit
44 generating unit
45 processing unit
46 providing unit

1. An information processing method executed by a computer, the information processing method comprising:
obtaining learning data which is to be used in learning of a base model that treats a text as input; and
performing a multistage learning operation using the learning data, and
generating the base model.

2. The information processing method according to claim 1, further comprising
obtaining the learning data that contains a first-type data constellation to be used in learning of general-purpose language capacity, and
performing the multistage learning operation that includes a first-stage learning operation which makes use of the first-type data constellation, and
generating the base model.

3. The information processing method according to claim 2, further comprising
obtaining the first-type data constellation containing natural language data to be used in learning of a large-scale language model.

4. The information processing method according to claim 1, further comprising
obtaining the learning data that contains a second-type data constellation to be used in learning of language capacity meant for specific processing, and
performing the multistage learning operation that includes a second-stage learning operation which makes use of the second-type data constellation, and
generating the base model.

5. The information processing method according to claim 4, further comprising
obtaining the learning data that contains the second-type data constellation representing data related to a posting on Internet.

6. The information processing method according to claim 5, further comprising
obtaining the second-type data constellation that contains a text corresponding to a sentence posted on Internet.

7. The information processing method according to claim 6, further comprising
obtaining the second-type data constellation that contains a text corresponding to a question posted on Internet.

8. The information processing method according to claim 6, further comprising
obtaining the second-type data constellation that contains a text corresponding to an answer posted on Internet.

9. The information processing method according to claim 1, further comprising
performing the multistage learning operation that includes a third-stage learning operation in which learning is performed by increasing number of layers of the base model, and
generating the base model.

10. The information processing method according to claim 9, further comprising
performing the third-stage learning operation that makes use of data used in learning of language capacity meant for specific processing, and
generating the base model.

11. The information processing method according to claim 10, further comprising
performing the third-stage learning operation using data related to a posting on Internet, and
generating the base model.

12. The information processing method according to claim 11, further comprising
performing the third-stage learning operation using a text corresponding to a sentence posted on Internet, and
generating the base model.

13. The information processing method according to claim 9, further comprising
performing the third-stage learning operation in a repeated manner,
performing an operation of increasing number of layers of the base model and performing a learning operation with respect to the base model having increased number of layers, and
generating the base model.

14. The information processing method according to claim 1, further comprising
performing learning using information other than a sentence,
generating the base model, and
generating a fine-tuned model by fine-tuning the base model to be applicable to a predetermined task.

15. The information processing method according to claim 14, further comprising
generating the base model, and
generating the fine-tuned model that has a different input of input information than the base model.

16. The information processing method according to claim 14, further comprising
generating the base model, and
generating the fine-tuned model that has same order of input of input information as the base model.

17. The information processing method according to claim 14, further comprising
generating the base model that treats, as input, a plurality of sets of input information containing post-conversion information obtained by conversion of information other than a sentence text representing the sentence, and
generating the fine-tuned model.

18. The information processing method according to claim 1, further comprising
using label information as input information in learning of the base model.

19. An information processing apparatus comprising:
an obtaining unit that obtains learning data which is to be used in learning of a base model that treats a text as input; and
a generating unit that
performs a multistage learning operation using the learning data, and
generates the base model.

20. An information processing program that causes a computer to execute:
obtaining learning data which is to be used in learning of a base model that treats a text as input; and
performing a multistage learning operation using the learning data, and
generating the base model.
